(19) United States
(12) Patent Application Publication
(10) Pub. No.: US 2025/0164845 A1
(43) Pub. Date: May 22, 2025

(54) Reflective optical stack for switchable directional display

(71) Applicant: RealD Spark, LLC, BOULDER, CO (US)

(72) Inventors: Jonathan Harrold, Leamington Spa (GB); Michael G Robinson, BOULDER, CO (US); Graham J. Woodgate, Henley-on-Thames (GB)

(21) Appl. No.: 18/947,149

(22) Filed: Nov. 14, 2024

Related U.S. Application Data
(60) Provisional application No. 63/601,384, filed on Nov. 21, 2023.

(51) Int. Cl. G02F 1/137; G02F 1/1335

(52) U.S. Cl. CPC G02F 1/13737; G02F 1/133536

(57) ABSTRACT

A switchable privacy display comprises a spatial light modulator and a compensated switchable guest-host liquid crystal retarder arranged between an output display polariser of the spatial light modulator and an additional polariser. A reflective polariser is arranged between the guest-host liquid crystal retarder and the output display polariser. In privacy mode, on-axis light from the spatial light modulator is directed without loss, whereas off-axis light has reduced luminance. The visibility of the display to off-axis snoopers is reduced by luminance reduction and reflection increase over a wide polar field. The colour of the reflected light may be modified by selection of the spectral absorption of the guest material in correspondence to the spectral transmission of the additional polariser. An aesthetically desirable display appearance may be achieved in privacy mode from non-viewing directions. In wide-angle mode, the switchable liquid crystal retardance is adjusted so off-axis luminance and reflectance is substantially unmodified.

### TECHNICAL FIELD

This disclosure generally relates to illumination from light modulation devices, and more specifically relates to switchable optical stacks for providing control of illumination for use in a display including a privacy display.

### BACKGROUND

Privacy displays provide image visibility to a primary user that is typically in an on-axis position and reduced visibility of image content to a snooper, that is typically in an off-axis position. A privacy function may be provided by micro-louvre optical films that transmit some light from a display in an on-axis direction with low luminance in off-axis positions. However such films have high losses for head-on illumination and the micro-louvres may cause Moiré artefacts due to beating with the pixels of the spatial light modulator. The pitch of the micro-louvre may need selection for panel resolution, increasing inventory and cost.

Switchable privacy displays may be provided by control of the off-axis optical output.

Control may be provided by means of luminance reduction, for example by means of switchable backlights for a liquid crystal display (LCD) spatial light modulator. Display backlights in general employ waveguides and edge emitting sources. Certain imaging directional backlights have the additional capability of directing the illumination through a display panel into viewing windows. An imaging system may be formed between multiple sources and the respective window images. One example of an imaging directional backlight is an optical valve that may employ a folded optical system and hence may also be an example of a folded imaging directional backlight. Light may propagate substantially without loss in one direction through the optical valve while counter-propagating light may be extracted by reflection off tilted facets as described in U.S. Pat. No. 9,519,153, which is herein incorporated by reference in its entirety.

Control of off-axis privacy may further be provided by means of contrast reduction, for example by adjusting the liquid crystal bias tilt in an In-Plane-Switching LCD.

### BRIEF SUMMARY

According to a first aspect of the present disclosure there is provided a display device comprising: a spatial light modulator comprising a layer of addressable pixels; a display polariser arranged on an output side of the spatial light modulator, the display polariser being a linear polariser; a reflective polariser arranged on an output side of the display polariser, the reflective polariser being a linear polariser, wherein the reflective polariser and the display polariser have electric vector transmission directions that are parallel; an additional polariser arranged on the output side of the reflective polariser, the additional polariser being a linear polariser; and a guest-host liquid crystal retarder arranged between the additional polariser and the reflective polariser, the guest-host liquid crystal retarder comprising a liquid crystal layer comprising a guest material and a host material, wherein the guest material is an anisotropic material and the host material is a liquid crystal material, the guest-host liquid crystal retarder being arranged on the same side of the spatial light modulator as the display polariser with the display polariser arranged between the guest-host liquid crystal retarder and the spatial light modulator, wherein the optical axis of the guest-host liquid crystal retarder has an alignment component perpendicular to the plane of the guest-host liquid crystal retarder in at least a state of the host material. Advantageously a display may be provided with a privacy function. High security factor may be achieved for image snoopers while high image visibility for display users. The optical stack may be provided with low thickness and low cost. An aesthetically desirable display appearance may be provided to snoopers, and user confidence in the provision of high security factor improved.

The anisotropic material may be an anisotropic optical absorber. The anisotropic material may be a dichroic dye or a pleochroic dye. Advantageously a low stray light display may be provided, and off-axis luminance may be reduced for a privacy display. Increased size of polar region may be achieved over which desirable security factor is achieved.

The guest-host liquid crystal retarder may be a switchable liquid crystal retarder further comprising transparent electrodes arranged to apply a voltage capable of switching the host material between different states. The display device may further comprise a control system arranged to control the voltage applied across the electrodes of the at least one switchable liquid crystal retarder. A display capable of switching between a share mode, and a privacy mode or a low stray light mode of operation may be provided.

In each direction inclined to a normal to the display device, the difference between the maximum reflectance of the display device and the minimum reflectance of the display device across all switchable states of the host material may be at most 15%. In each switchable state of the host material, considering a combination of: the additional polariser; the guest-host liquid crystal retarder and any other retarder arranged between the additional polariser and the reflective polariser; and the reflective polariser, the contribution to the reflectance of the display device provided by that combination and excluding any surface reflections besides reflection from the reflective polariser may be at most 15% in all directions inclined to a normal to the display device.

A display with increased size of region of increased security factor may advantageously be achieved. An aesthetically desirable display appearance to a snooper may be achieved to increase user confidence in the privacy of their image data.

In at least one switchable state of the host material, the optical axis of the guest-host liquid crystal retarder may have an alignment component perpendicular to the plane of the guest-host liquid crystal retarder. A privacy mode of operation may be achieved advantageously with angular dependence of transmission and reflection.

The guest material may have a transmission in the visible spectrum that varies with wavelength. The reflected colour of light from the display may advantageously be modified. Improved aesthetic appearance may be achieved.

The additional polariser may have a transmission in the visible spectrum that monotonically increases with increasing wavelengths up to 475 nm and that is greater at all visible wavelengths above 475 nm than at a wavelength of 475 nm, and the transmission in the visible spectrum of the guest material may have a maximum value at a wavelength of at least 475 nm, preferably at least 500 nm. An efficient colour reflection with a green, red or yellow hue may advantageously be achieved with a high security factor.

The additional polariser may have a transmission in the visible spectrum that is greater at all wavelengths below 475 nm than at 475 nm, and the transmission in the visible spectrum of the guest material is greater at all wavelengths below 500 nm than at any wavelength in the range from 500 nm to 550 nm. An efficient colour reflection with a blue, red or magenta hue may advantageously be achieved with a high security factor.

The anisotropic material may comprise anisotropic metallic nanomaterial. The anisotropic metallic nanomaterial may have a transparent electrically insulating surface layer. The insulating surface layer may be a coating or may be formed chemically such as a transparent oxide for example. Advantageously off-axis ambient light may be reflected to provide increased security factor to an off-axis snooper and increase the privacy effect.

The volume of the guest material may be less than 3%, preferably less than 2% and most preferably less than 1% of the volume of the host material. The weight of the guest material may be less than 3%, preferably less than 2% and most preferably less than 1% of the weight of the host material. The on-axis extinction coefficient of the guest-host liquid crystal retarder in at least one mode of operation may be at least 60%, preferably at least 80% and most preferably at least 90%. Advantageously desirable efficiency may be achieved for a display user, while the size of the polar region for which acceptable security factor is achieved may be increased. The illuminance of the ambient environment for desirable security factor may be reduced, and the display may provide desirable privacy in darker environments.

The guest material may comprise a positive dichroic material or a positive pleochroic material and in at least one of the states, the optical axis of the guest-host liquid crystal retarder may have an alignment component in the plane of the guest-host liquid crystal retarder that is orthogonal to the electric vector transmission direction of the display polariser. Advantageously high transmission may be obtained over a wide polar region to achieve a share mode of operation.

The display device may further comprise at least one passive retarder arranged between the additional polariser and the reflective polariser. Advantageously the size of the region for which desirable security factor is achieved may be increased.

The display polariser, the reflective polariser and the additional polariser may have electric vector transmission directions that are parallel. Advantageously display efficiency may be increased.

The switchable liquid crystal retarder may comprise two surface alignment layers disposed adjacent to the layer of liquid crystal material and on opposite sides thereof and each arranged to provide homeotropic alignment in the adjacent liquid crystal material. By the application of an electric field, advantageously a display may be switched between a low stray light display mode such as a privacy mode to a wide-angle mode for multiple display users and increased image uniformity. In that case, the following features may be present.

The host material may be a liquid crystal material with a negative dielectric anisotropy.

The liquid crystal layer may have a retardance for light of a wavelength of 550 nm in a range from 500 nm to 1000 nm, preferably in a range from 600 nm to 900 nm and most preferably in a range from 700 nm to 850 nm.

The at least one passive retarder may comprise a retarder having its optical axis perpendicular to the plane of the retarder, the at least one passive retarder having a retardance for light of a wavelength of 550 nm in a range from −300 nm to −900 nm, preferably in a range from −450 nm to −800 nm and most preferably in a range from −500 nm to −725 nm. Alternatively, the at least one passive retarder may comprise a pair of retarders which have optical axes in the plane of the retarders that are crossed, each retarder of the pair of retarders having a retardance for light of a wavelength of 550 nm in a range from 300 nm to 800 nm, preferably in a range from 500 nm to 700 nm and most preferably in a range from 550 nm to 675 nm. Advantageously low voltage operation may be provided in a wide-angle mode of operation, reducing power consumption.

The switchable liquid crystal retarder may comprise two surface alignment layers disposed adjacent to the layer of liquid crystal material and on opposite sides thereof and each arranged to provide homogeneous alignment in the adjacent liquid crystal material. In that case, the following features may be present.

The layer of liquid crystal material of the switchable liquid crystal retarder may comprise a liquid crystal material with a positive dielectric anisotropy.

The layer of liquid crystal material may have a retardance for light of a wavelength of 550 nm in a range from 500 nm to 1000 nm, preferably in a range from 600 nm to 850 nm and most preferably in a range from 700 nm to 800 nm.

The at least one passive compensation retarder may comprise a retarder having its optical axis perpendicular to the plane of the retarder, the at least one passive retarder having a retardance for light of a wavelength of 550 nm in a range from −300 nm to −700 nm, preferably in a range from −350 nm to −600 nm and most preferably in a range from −400 nm to −500 nm. Alternatively, the at least one passive compensation retarder may comprise a pair of retarders which have optical axes in the plane of the retarders that are crossed, each retarder of the pair of retarders having a retardance for light of a wavelength of 550 nm in a range from 300 nm to 800 nm, preferably in a range from 350 nm to 650 nm and most preferably in a range from 450 nm to 550 nm. Advantageously the visibility of material flow may be reduced.

The switchable liquid crystal retarder may comprise two surface alignment layers disposed adjacent to the layer of liquid crystal material and on opposite sides thereof, one of the surface alignment layers being arranged to provide homeotropic alignment in the adjacent liquid crystal material and the other of the surface alignment layers being arranged to provide homogeneous alignment in the adjacent liquid crystal material. In that case, the following features may be present.

The surface alignment layer may be arranged to provide homogeneous alignment between the layer of liquid crystal material and the compensation retarder.

The layer of liquid crystal material may have a retardance for light of a wavelength of 550 nm in a range from 700 nm to 2000 nm, preferably in a range from 1000 nm to 1500 nm and most preferably in a range from 1200 nm to 1500 nm.

The at least one passive compensation retarder may comprise a retarder having its optical axis perpendicular to the plane of the retarder, the at least one passive retarder having a retardance for light of a wavelength of 550 nm in a range from −400 nm to −1800 nm, preferably in a range from −700 nm to −1500 nm and most preferably in a range from −900 nm to −1300 nm. Alternatively, the at least one passive compensation retarder may comprise a pair of retarders which have optical axes in the plane of the retarders that are crossed, each retarder of the pair of retarders having a retardance for light of a wavelength of 550 nm in a range from 400 nm to 1800 nm, preferably in a range from 700 nm to 1500 nm and most preferably in a range from 900 nm to 1300 nm.

Each alignment layer may have a pretilt having a pretilt direction with a component in the plane of the liquid crystal layer that is parallel or anti-parallel or orthogonal to the electric vector transmission direction of the display polariser. The display device may further comprise: an additional polariser arranged on the same side of the spatial light modulator as the display polariser; and plural retarders arranged between the additional polariser and the display polariser, wherein the plural retarders comprise: a switchable liquid crystal retarder comprising a layer of liquid crystal material; and at least one passive compensation retarder. The guest-host liquid crystal retarder may be arranged to introduce no phase shift to polarisation components of light passed by the one of the display polariser and the additional polariser on the input side of the plural retarders along an axis along an optical axis inclined to the plane of the guest-host liquid crystal retarder. The axis may be normal to the plane of the guest-host liquid crystal retarder.

The guest-host liquid crystal retarder may be arranged to introduce a phase shift to polarisation components of light passed by the one of the display polariser and the additional polariser on the input side of the plural retarders along an axis inclined to the optical axis in at least a state of the guest-host liquid crystal retarder.

The guest-host liquid crystal retarder may be arranged to not affect the luminance of light passing through the display polariser and the guest-host liquid crystal retarder along an axis along a normal to the plane of the guest-host liquid crystal retarder. The guest-host liquid crystal retarder may be arranged to reduce the luminance of light passing through the display polariser and the guest-host liquid crystal retarder along an axis inclined to a normal to the plane of the retarders.

The display device may further comprise at least one further retarder and a further additional polariser, wherein the at least one further retarder is arranged between the first-mentioned additional polariser and the further additional polariser.

The display device may further comprise a further additional polariser arranged on the input side of the spatial light modulator and at least one further retarder arranged between the at least one further additional polariser and the input polariser.

The display device may further comprise a backlight arranged to output light, wherein the spatial light modulator may be a transmissive spatial light modulator arranged to receive output light from the backlight. Advantageously a low cost display apparatus may be achieved. The backlight may be arranged to have low off-axis luminance. Advantageously the security factor for off-axis viewing locations may be increased.

The spatial light modulator may comprise an emissive spatial light modulator arranged to output light and the display polariser may be an output display polariser arranged on the output side of the emissive spatial light modulator. Advantageously a thin and lightweight display apparatus may be provided.

The various features and alternatives set out above with respect to the first aspect of the present disclosure may similarly be applied to the second aspect of the present disclosure.

Embodiments of the present disclosure may be used in a variety of optical systems. The embodiments may include or work with a variety of projectors, projection systems, optical components, displays, microdisplays, computer systems, processors, self-contained projector systems, visual and/or audio-visual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1A is a schematic diagram illustrating in side perspective view an optical stack of a display device comprising a front switchable guest-host liquid crystal retarder and an additional polariser;

FIG. 1B is a schematic diagram illustrating in front view alignment of optical layers in the optical stack of FIG. 1A;

FIG. 1C is a schematic diagram illustrating in side perspective view an optical stack of a display device comprising an emissive spatial light modulator and a switchable guest-host liquid crystal retarder arranged on the output side of the emissive spatial light modulator;

FIG. 1D is a schematic diagram illustrating in side perspective view a view angle control optical element comprising a passive guest-host liquid crystal retarder, a switchable guest-host liquid crystal retarder and a control polariser;

FIG. 2A is a schematic diagram illustrating in side perspective view a switchable guest-host liquid crystal retarder in a privacy mode of operation;

FIG. 2B is a schematic graph illustrating the simulated variation of output transmission with polar direction for the transmitted light rays in FIG. 2A;

FIG. 2C is a schematic graph illustrating the simulated variation of output transmission with polar direction for the transmitted light rays in FIG. 2A with a first concentration of guest dichroic dye material;

FIG. 2D is a schematic graph illustrating the simulated variation of output transmission with polar direction for the transmitted light rays in FIG. 2A with a second concentration of guest dichroic dye material;

FIG. 2E is a schematic graph illustrating the simulated variation of output transmission with lateral angle at zero elevation with varying concentration of dichroic dye for the transmitted light rays in FIG. 2A;

FIG. 2F is a schematic graph illustrating the simulated variation of normalised output transmission with lateral angle at zero elevation with varying concentration of dichroic dye for the transmitted light rays in FIG. 2A;

FIG. 2G is a schematic diagram illustrating in side perspective view a switchable guest-host liquid crystal retarder in a wide-angle mode of operation;

FIG. 2H is a schematic graph illustrating the variation of output transmission with polar direction for the transmitted light rays in FIG. 2G;

FIG. 3A is a schematic diagram illustrating in perspective side view an arrangement of a switchable compensated guest-host liquid crystal retarder comprising a negative C-plate in a privacy mode;

FIG. 3B is a schematic diagram illustrating in side view propagation of output light from a spatial light modulator through the optical stack of FIG. 3A in a privacy mode;

FIG. 3C is a schematic graph illustrating the simulated variation of output transmission with polar direction for the transmitted light rays in FIG. 3B with no guest dichroic dye material;

FIG. 3D is a schematic graph illustrating the simulated variation of output transmission with polar direction for the transmitted light rays in FIG. 3B with a first concentration of guest dichroic dye material;

FIG. 3E is a schematic graph illustrating the simulated variation of output transmission with polar direction for the transmitted light rays in FIG. 3B with a second concentration of guest dichroic dye material;

FIG. 3F is a schematic diagram illustrating in perspective side view an arrangement of a switchable compensated retarder comprising a negative C-plate in a wide-angle mode;

FIG. 3G is a schematic diagram illustrating in side view propagation of output light from a spatial light modulator through the optical stack of FIG. 3F in a wide-angle mode;

FIG. 3H is a schematic graph illustrating the variation of output transmission with polar direction for the transmitted light rays in FIG. 3G;

FIG. 4A is a schematic diagram illustrating in top view propagation of ambient illumination light through the optical stack of FIG. 1A in a share mode;

FIG. 4B is a schematic diagram illustrating in top view propagation of ambient illumination light through the optical stack of FIG. 1A in a privacy mode;

FIG. 5A is a schematic diagram illustrating in top view propagation of reflected light from the view angle control element;

FIG. 5B is a schematic diagram illustrating in top view a measurement method to determine the brightness of a light source at a measurement angle ϕ;

FIG. 5C and FIG. 5D are flow charts illustrating methods for the measurement of display device reflectance;

FIG. 6A is a schematic graph illustrating the spectral variation of transmission for a conventional dichroic additional polariser and a high blue transmission dichroic additional polariser;

FIG. 6B is a schematic graph illustrating the spectral variation of reflectance for a display device comprising a conventional dichroic additional polariser and a display device comprising a high blue transmission dichroic additional polariser wherein the guest-host dye has uniform transmission with wavelength;

FIG. 6C is a schematic graph illustrating the spectral variation of (i) the transmission profile of a high blue transmission dichroic additional polariser, (ii) the illustrative transmission profile of a lilac dye material of a guest-host liquid crystal retarder for use with the high blue transmission dichroic polariser and (iii) the normalised reflectance profile for a display device comprising the high blue transmission dichroic polariser and the lilac dye material;

FIG. 6D is a schematic graph illustrating the spectral variation of (i) the transmission profile of a conventional dichroic additional polariser, (ii) the illustrative transmission profile of a green dye material of a guest-host liquid crystal retarder for use with the high blue transmission dichroic polariser and (iii) the normalised reflectance profile for a display device comprising the conventional dichroic polariser and the green dye material;

FIG. 7A is a schematic diagram illustrating in front perspective view observation of transmitted output light for a display operating in privacy mode;

FIG. 7B is a schematic diagram illustrating in front perspective views the appearance of the display of FIGS. 1A-C operating in privacy mode;

FIG. 8A is a schematic diagram illustrating in side view an automotive vehicle with a switchable directional display arranged within the vehicle cabin for both entertainment and sharing modes of operation;

FIG. 8B is a schematic diagram illustrating in top view an automotive vehicle with a switchable directional display arranged within the vehicle cabin in an entertainment mode of operation;

FIG. 8C is a schematic diagram illustrating in top view an automotive vehicle with a switchable directional display arranged within the vehicle cabin in a sharing mode of operation;

FIG. 8D is a schematic diagram illustrating in top view an automotive vehicle with a switchable directional display arranged within the vehicle cabin for both night-time and day-time modes;

FIG. 8E is a schematic diagram illustrating in side view an automotive vehicle with a switchable directional display arranged within the vehicle cabin in a night-time mode of operation;

FIG. 8F is a schematic diagram illustrating in side view an automotive vehicle with a switchable directional display arranged within the vehicle cabin in a day-time mode of operation;

FIG. 9A is a schematic diagram illustrating in perspective side view an arrangement of a switchable compensated retarder in a wide-angle mode comprising crossed A-plate passive compensation retarders and homeotropically aligned switchable liquid crystal retarder;

FIG. 9B is a schematic diagram illustrating in perspective side view an arrangement of a switchable compensated retarder in a privacy mode comprising crossed A-plate passive compensation retarders and homeotropically aligned switchable liquid crystal retarder;

FIG. 9C is a schematic graph illustrating the variation of output transmission with polar direction for transmitted light rays in FIG. 9A in a wide-angle mode;

FIG. 9D is a schematic graph illustrating the variation of output transmission with polar direction for transmitted light rays in FIG. 9B in a privacy mode;

FIG. 10A and FIG. 10B are schematic diagrams illustrating in perspective side view an arrangement of a switchable compensated retarder in a wide-angle mode and a privacy mode respectively comprising a homogeneously aligned switchable liquid crystal retarder and a passive negative C-plate retarder;

FIG. 11A, FIG. 11B, and FIG. 11C are schematic graphs illustrating the variation of output transmission with polar direction for transmitted light rays of switchable compensated retarder comprising a homogeneously aligned liquid crystal cell and a negative C-plate in a privacy mode and for two different wide-angle mode addressing drive voltages respectively;

FIG. 12 is a schematic diagram illustrating in perspective side view an arrangement of a switchable compensated retarder in a privacy mode comprising crossed A-plate passive compensation retarders and homogeneously aligned switchable liquid crystal retarder;

FIG. 13, FIG. 14, and FIG. 15 are schematic graphs illustrating the variation of output transmission with polar direction for transmitted light rays of switchable compensated retarder comprising a homogeneously aligned liquid crystal cell and crossed A-plates in a privacy mode and wide-angle modes for different drive voltages;

FIG. 16 is a schematic diagram illustrating in perspective side view an arrangement of a switchable compensated retarder in a privacy mode comprising crossed A-plate passive compensation retarders and homogeneously aligned switchable liquid crystal retarder, further comprising a passive rotation retarder;

FIG. 17 is a schematic diagram illustrating in perspective side view an arrangement of a switchable compensated retarder in a privacy mode comprising a homogeneously and homeotropically aligned switchable liquid crystal retarder and a passive negative C-plate retarder;

FIG. 18 is a schematic graph illustrating the variation of output transmission with polar direction for transmitted light rays in FIG. 17 in a privacy mode;

FIG. 19 is a schematic graph illustrating the variation of output transmission with polar direction for transmitted light rays in FIG. 17 in a wide-angle mode; and

FIG. 20 is a schematic diagram illustrating in side perspective view an optical stack of a display device comprising an emissive spatial light modulator and a switchable guest-host liquid crystal retarder and an additional switchable guest-host liquid crystal retarder arranged on the output side of the emissive spatial light modulator.

### DETAILED DESCRIPTION

Terms related to optical retarders for the purposes of the present disclosure will now be described.

In a layer comprising a uniaxial birefringent material there is a direction governing the optical anisotropy whereas all directions perpendicular to it (or at a given angle to it) are optically equivalent.

Optical axis refers to the direction of propagation of an unpolarised light ray in the uniaxial birefringent material in which no birefringence is experienced by the ray. For light propagating in a direction orthogonal to the optical axis, the optical axis is the slow axis when linearly polarized light with an electric vector direction parallel to the slow axis travels at the slowest speed. The slow axis direction is the direction with the highest refractive index at the design wavelength. Similarly the fast axis direction is the direction with the lowest refractive index at the design wavelength.

For positive optical anisotropy uniaxial birefringent materials the slow axis direction is the extraordinary axis of the birefringent material. For negative optical anisotropy uniaxial birefringent materials the fast axis direction is the extraordinary axis of the birefringent material.

The terms half a wavelength and quarter a wavelength refer to the operation of a retarder for a design wavelength λ₀ that may typically be between 450 nm and 570 nm. In the present illustrative embodiments exemplary retardance values are provided for a wavelength of 550 nm unless otherwise specified.

The retarder provides a phase shift between two perpendicular polarization components of the light wave incident thereon and is characterized by the amount of relative phase, Γ, that it imparts on the two polarization components: which is related to the birefringence Δn and the thickness d of the retarder by

$$Γ = 2. π . Δ n . d / {λ}_{0} \qquad eqn . 1$$

In eqn. 1, Δn is defined as the difference between the extraordinary and the ordinary index of refraction, i.e.

$$Δ n = {n}_{e} - {n}_{o} \qquad eqn . 2$$

For a half wave retarder, the relationship between d, Δn, and λ₀ is chosen so that the phase shift between polarization components is Γ=π. For a quarter wave retarder, the relationship between d, Δn, and λ₀ is chosen so that the phase shift between polarization components is Γ=π/2.

The term half wave retarder herein typically refers to light propagating normal to the retarder and normal to the spatial light modulator.

Some aspects of the propagation of light rays through a transparent retarder between a pair of polarisers will now be described.

The state of polarisation (SOP) of a light ray is described by the relative amplitude and phase shift between any two orthogonal polarization components. Transparent retarders do not alter the relative amplitudes of these orthogonal polarisation components but act only on their relative phase. Providing a net phase shift between the orthogonal polarisation components alters the SOP whereas maintaining net relative phase preserves the SOP. In the current disclosure, the SOP may be termed the polarisation state.

A linear SOP has a polarisation component with a non-zero amplitude and an orthogonal polarisation component which has zero amplitude.

A linear polariser transmits a unique linear SOP that has a linear polarisation component parallel to the electric vector transmission direction of the linear polariser and attenuates light with a different SOP. The term “electric vector transmission direction” refers to a non-directional axis of the polariser parallel to which the electric vector of incident light is transmitted, even though the transmitted “electric vector” always has an instantaneous direction. The term “direction” is commonly used to describe this axis.

Absorbing polarisers are polarisers that absorb one polarisation component of incident light and transmit a second orthogonal polarisation component. Examples of absorbing linear polarisers are dichroic polarisers.

Reflective polarisers are polarisers that reflect one polarisation component of incident light and transmit a second orthogonal polarisation component. Examples of reflective polarisers that are linear polarisers are multilayer polymeric film stacks such as DBEF™ or APF™ from 3M Corporation, or wire grid polarisers such as ProFlux™ from Moxtek. Reflective linear polarisers may further comprise cholesteric reflective materials and a quarter waveplate arranged in series.

A retarder arranged between a linear polariser and a parallel linear analysing polariser that introduces no relative net phase shift provides full transmission of the light other than residual absorption within the linear polariser.

A retarder that provides a relative net phase shift between orthogonal polarisation components changes the SOP and provides attenuation at the analysing polariser.

In the present disclosure an ‘A-plate’ refers to an optical retarder utilizing a layer of birefringent material with its optical axis parallel to the plane of the layer. The plane of the retarders refers to the slow axis of the retarders extend in a plane, that is the x-y plane.

A ‘positive A-plate’ refers to positively birefringent A-plates, i.e. A-plates with a positive Δn.

In the present disclosure a ‘C-plate’ refers to an optical retarder utilizing a layer of birefringent material with its optical axis perpendicular to the plane of the layer. A ‘positive C-plate’ refers to positively birefringent C-plate, i.e. a C-plate with a positive Δn. A ‘negative C-plate’ refers to a negatively birefringent C-plate, i.e. a C-plate with a negative Δn.

In the present disclosure an ‘O-plate’ refers to an optical retarder utilizing a layer of birefringent material with its optical axis having a component parallel to the plane of the layer and a component perpendicular to the plane of the layer. A ‘positive O-plate’ refers to positively birefringent O-plates, i.e. O-plates with a positive Δn.

Achromatic retarders may be provided wherein the material of the retarder is provided with a retardance Δn·d that varies with wavelength λ as

$$Δ n . d / λ = κ \qquad eqn . 3$$

where κ is substantially a constant.

Examples of suitable materials include modified polycarbonates from Teijin Films. Achromatic retarders may be provided in the present embodiments to advantageously minimise colour changes between polar angular viewing directions which have low luminance reduction and polar angular viewing directions which have increased luminance reductions as will be described below.

Various other terms used in the present disclosure related to retarders and to liquid crystals will now be described.

A liquid crystal cell has a retardance given by Δn·d where Δn is the birefringence of the liquid crystal material in the liquid crystal cell and d is the thickness of the liquid crystal cell, independent of the alignment of the liquid crystal material in the liquid crystal cell.

Homogeneous alignment refers to the alignment of liquid crystals in switchable liquid crystal displays where molecules align substantially parallel to a substrate. Homogeneous alignment is sometimes referred to as planar alignment. Homogeneous alignment may typically be provided with a small pre-tilt such as 2 degrees, so that the molecules at the surfaces of the alignment layers of the liquid crystal cell are slightly inclined as will be described below. Pretilt is arranged to minimise degeneracies in switching of cells.

In the present disclosure, in the context of liquid crystal orientation, state refers to the orientation of the liquid crystal director at a particular applied voltage i.e. a voltage applied state. The state may be the zero voltage applied state.

In the present disclosure, homeotropic alignment is the state in which rod-like liquid crystalline molecules align substantially perpendicularly to the substrate. In discotic liquid crystals homeotropic alignment is defined as the state in which an axis of the column structure, which is formed by disc-like liquid crystalline molecules, aligns perpendicularly to a surface. In homeotropic alignment, pretilt is the tilt angle of the molecules that are close to the alignment layer and is typically close to 90 degrees and for example may be 88 degrees.

Liquid crystal molecules with positive dielectric anisotropy are switched from a homogeneous alignment (such as an A-plate retarder orientation) to a homeotropic alignment (such as a C-plate or O-plate retarder orientation) by means of an applied electric field.

Liquid crystal molecules with negative dielectric anisotropy are switched from a homeotropic alignment (such as a C-plate or O-plate retarder orientation) to a homogeneous alignment (such as an A-plate retarder orientation) by means of an applied electric field.

Rod-like molecules have a positive birefringence so that nₑ>nₒ as described in eqn. 2. Discotic molecules have negative birefringence so that nₑ<nₒ.

Positive retarders such as A-plates, positive O-plates and positive C-plates may typically be provided by stretched films or rod-like liquid crystal molecules. Negative retarders such as negative C-plates may be provided by stretched films or discotic like liquid crystal molecules.

Parallel liquid crystal cell alignment refers to the alignment direction of homogeneous alignment layers being parallel or more typically antiparallel. In the case of pre-tilted homeotropic alignment, the alignment layers may have components that are substantially parallel or antiparallel. Hybrid aligned liquid crystal cells may have one homogeneous alignment layer and one homeotropic alignment layer. Twisted liquid crystal cells may be provided by alignment layers that do not have parallel alignment, for example oriented at 90 degrees to each other.

A dichroic material has different absorption coefficients for light polarized in different directions. A pleochroic material absorbs different wavelengths of light differently depending on the direction of incidence of the rays or their plane of polarization, often resulting in the appearance of different colours according to the direction of view.

Guest-host liquid crystal materials comprise a liquid crystal host material and a guest material comprising an anisotropic absorbing dye. The liquid crystal host material has a director direction that represents the direction of the preferred orientation of molecules in the neighbourhood of any point. By way of comparison with the present embodiments, in the standard type of guest host display, linearly polarized input light is absorbed by the dye molecules which are homogeneously aligned with the polarizer transmission direction resulting in a black display state to the head-on viewer. When an electric field is applied to the guest host liquid crystal cell, the liquid crystal host re-orientation causes the dye guest to reorient with it so that it is parallel to the applied electric field and so the input polarized light passes substantially without attenuation resulting in a white display state to the head-on viewer. In both cases the off-axis viewer sees the same display state as the head-on viewer.

This is completely different from the guest host configuration used in this specification where the head-on display brightness state of the guest host system is substantially unchanged by the application of the electric field and only the off-axis viewing properties are altered.

When the liquid crystal host re-orients as described above there is a change in the retardance imparted to input light that arises from the optical anisotropy of the liquid crystal molecules. In some (but not all) embodiments of a guest host system described herein the main operating effect is the re-orientation of the light absorbing dye molecules and the retardance effect may be small so that only a negligible retardance is imparted to input light in the visible wavelengths. This means liquid crystal host materials with low optical anisotropy may be used.

In positive dichroic and pleochroic guest-host materials the major absorption axis of the dichroic material aligns with the liquid crystal host director direction. In negative dichroic and pleochroic guest-host materials the major absorption axis aligns perpendicular to the liquid crystal host director direction.

The present description typically refer to positive dichroic dye materials, however pleochroic and negative dichroic and pleochroic materials may also be used in the present embodiments as will be further described.

The order parameter is used to describe the ordering of a liquid crystal and for liquid crystals in the nematic phase is typically less than 0.8, where an order parameter of 1 is for a perfectly aligned arrangement of liquid crystal molecules and an order parameter of 0 is for an isotropic arrangement.

Transmissive spatial light modulators may further comprise retarders between the input display polariser and the output display polariser for example as disclosed in U.S. Pat. No. 8,237,876, which is herein incorporated by reference in its entirety. Such retarders (not shown) are in a different place to the passive retarders of the present embodiments. Such retarders compensate for contrast degradations for off-axis viewing locations, which is a different effect to the luminance reduction for off-axis viewing positions of the present embodiments.

Optical isolation retarders provided between the display polariser and an OLED display emission layer are described further in U.S. Pat. No. 7,067,985, which is herein incorporated by reference in its entirety. Optical isolation retarders are in a different place to the passive retarders of the present embodiments. Isolation retarder reduces frontal reflections of ambient light from the OLED display emission layer which is a different effect to the luminance reduction of emitted light for off-axis viewing positions of the present embodiments.

Transmissive spatial light modulators may further comprise retarders between the input display polariser and the output display polariser for example as disclosed in U.S. Pat. No. 8,237,876, which is herein incorporated by reference in its entirety. Such retarders (not shown) are in a different place to the passive retarders of the present embodiments. Such retarders compensate for contrast degradations for off-axis viewing locations, which is a different effect to the luminance reduction for off-axis viewing positions of the present embodiments.

A private mode of operation of a display is one in which a viewer sees a low contrast sensitivity such that an image is not clearly visible. Contrast sensitivity is a measure of the ability to discern between luminances of different levels in a static image. Inverse contrast sensitivity may be used as a measure of visual security, in that a high visual security level (VSL) corresponds to low image visibility.

For a privacy display providing an image to a viewer, visual security may be given as:

$$V = ( Y + R ) / ( Y - K ) \qquad eqn . 4$$

where V is the visual security level (VSL), Y is the luminance of the white state of the display at a snooper viewing angle (which may be termed a non-viewing direction), K is the luminance of the black state of the display at the snooper viewing angle and R is the luminance of reflected light from the display.

Panel contrast ratio is given as:

$$C = Y / K \qquad eqn . 5$$

so the visual security level may be further given as:

$$V = ( P . {Y}_{max} + I . ρ / π ) / ( P . ( {Y}_{max} - {Y}_{max} / C ) ) \qquad eqn . 6$$

where: Yₘₐₓ is the maximum luminance of the display; P is the off-axis relative luminance typically defined as the ratio of luminance at the snooper angle to the maximum luminance Yₘₐₓ; C is the image contrast ratio; ρ is the surface reflectance; π is a solid angle factor (with units steradians) and I is the illuminance. The units of Yₘₐₓ are the units of I divided by solid angle in units of steradian.

The luminance of a display varies with angle and so the maximum luminance of the display Yₘₐₓ occurs at a particular angle that depends on the configuration of the display.

In many displays, the maximum luminance Yₘₐₓ occurs head-on, i.e. normal to the display. Any display device disclosed herein may be arranged to have a maximum luminance Yₘₐₓ that occurs head-on, in which case references to the maximum luminance of the display device Yₘₐₓ may be replaced by references to the luminance normal to the display device.

Alternatively, any display described herein may be arranged to have a maximum luminance Yₘₐₓ that occurs at a polar angle to the normal to the display device that is greater than 0°. By way of example, the maximum luminance Yₘₐₓ may occur at a non-zero polar angle and at an azimuth angle that has for example zero lateral angle so that the maximum luminance is for an on-axis user that is looking down on to the display device. The polar angle may for example be 10 degrees and the azimuthal angle may be the northerly direction (90 degrees anti-clockwise from easterly direction). The viewer may therefore desirably see a high luminance at typical non-normal viewing angles.

The off-axis relative luminance, P is sometimes referred to as the privacy level. However, such privacy level P describes relative luminance of a display at a given polar angle compared to head-on luminance, and in fact is not a measure of privacy appearance.

The illuminance, I is the luminous flux per unit area that is incident on the display and reflected from the display towards the viewer location. For Lambertian illuminance, and for displays with a Lambertian front diffuser illuminance I is invariant with polar and azimuthal angles. For arrangements with a display with non-Lambertian front diffusion arranged in an environment with directional (non-Lambertian) ambient light, illuminance I varies with polar and azimuthal angle of observation.

Thus in a perfectly dark environment, a high contrast display has VSL of approximately 1.0. As ambient illuminance increases, the perceived image contrast degrades, VSL increases and a private image is perceived.

For typical liquid crystal displays the panel contrast C is above 100:1 for almost all viewing angles, allowing the visual security level to be approximated to:

$$V = 1 + I . ρ / ( π . P . {Y}_{max} ) \qquad eqn . 7$$

In the present embodiments, in addition to the exemplary definition of eqn. 4, other measurements of visual security level, V may be provided, for example to include the effect on image visibility to a snooper of snooper location, image contrast, image colour and white point and subtended image feature size. Thus the visual security level may be a measure of the degree of privacy of the display but may not be restricted to the parameter V.

The perceptual image security may be determined from the logarithmic response of the eye, such that a Security Factor, S is given by

$$S = {log}_{10} ( V ) \qquad eqn . 8$$

$$S = {log}_{10} ( 1 + α . ρ / ( π . P ) ) \qquad eqn . 9$$

where α is the ratio of illuminance I to maximum luminance Yₘₐₓ.

Desirable limits for S were determined in the following manner. In a first step a privacy display device was provided. Measurements of the variation of privacy level, P(θ) of the display device with polar viewing angle and variation of reflectance ρ(θ) of the display device with polar viewing angle were made using photopic measurement equipment. A light source such as a substantially uniform luminance lightbox was arranged to provide illumination from an illuminated region that was arranged to illuminate the privacy display device along an incident direction for reflection to viewer positions at a polar angle of greater than 0° to the normal to the display device. The variation I(θ) of illuminance of a substantially Lambertian emitting lightbox with polar viewing angle was determined by and measuring the variation of recorded reflective luminance with polar viewing angle taking into account the variation of reflectance p(θ). The measurements of P(θ), ρ(θ) and I(θ) were used to determine the variation of Security Factor S(θ) with polar viewing angle along the zero elevation axis.

In a second step a series of high contrast images were provided on the privacy display including (i) small text images with maximum font height 3 mm, (ii) large text images with maximum font height 30 mm and (iii) moving images.

In a third step each viewer (with eyesight correction for viewing at 1000 mm where appropriate) viewed each of the images from a distance of 1000 mm, and adjusted their polar angle of viewing at zero elevation until image invisibility was achieved for one eye from a position near on the display at or close to the centre-line of the display. The polar location of the viewer's eye was recorded. From the relationship S(θ), the security factor at said polar location was determined. The measurement was repeated for the different images, for various display luminance Yₘₐₓ, different lightbox illuminance I(θ=0), for different background lighting conditions and for different viewers.

From the above measurements S<1.0 provides low or no visual security, and S≥1 makes the image not visible. In the range 1.0≤S<1.5, even though the image is not visible for practical purposes, some features of the image may still be perceived dependent on the contrast, spatial frequency and temporal frequency of image content, whereas in the range 1.5≤S<1.8, the image is not visible for most images and most viewers and in the range S≥1.8 the image is not visible, independent of image content for all viewers.

In practical display devices, this means that it is desirable to provide a value of S for an off-axis viewer who is a snooper that meets the relationship S≥Sₘᵢₙ, where: Sₘᵢₙ has a value of 1.0 or more to achieve the effect that in practical terms the displayed image is not visible to the off-axis viewer.

At an observation angle θ in question, the security factor Sₙ for a region of the display labelled by the index n is given from eqn. 8 and eqn. 9 by:

$${S}_{n} ( θ ) = {log}_{10} [ 1 + {ρ}_{n} ( θ ) . α ( θ ) / ( π . {P}_{n} ( θ ) ) ] \qquad eqn . 10$$

where: α is the ratio of illuminance I(θ) onto the display that is reflected from the display to the angle in question and with units lux (lumen·m⁻²), to maximum luminance Yₘₐₓ with units of nits (lumen·m⁻²·sr⁻¹) where the units of a are steradians, x is a solid angle in units of steradians, ρₙ(θ) is the reflectance of the display device along the observation direction in the respective n^{th} region, and Pₙ(θ) is the ratio of the luminance of the display device along the observation direction in the respective n^{th} region.

In human factors measurement, it has been found that desirable privacy displays of the present embodiments described hereinbelow typically operate with security factor Sₙ≥1.0 at the observation angle when the value of the ratio α of illuminance I to maximum luminance Yₘₐₓ is 4.0. For example, the illuminance I(θ=−45°) that illuminates the display and is directed towards the snooper at the observation direction (θ=+45°) after reflection from the display may be 1000 lux and the maximum display illuminance Yₘₐₓ that is provided for the user may be 250 nits. This provides an image that is not visible for a wide range of practical displays.

More preferably, the display may have improved characteristics of reflectance ρₙ(θ=45°) and privacy Pₙ(0=45°) by operating with security factor Sₙ≥1.0 at the observation angle when the ratio α is 2.0. Such an arrangement desirably improves the relative perceived brightness and contrast of the display to the primary user near to the direction of Yₘₐₓ while achieving desirable security factor, Sₙ≥1.0. Most preferably, the display may have improved characteristics of reflectance σₙ(0=45°) and privacy Pₙ(θ=45°) by operating with security factor Sₙ≥1.0 at the observation angle when the ratio α is 1.0. Such an arrangement achieves desirably high perceived brightness and contrast of the display to the primary user near to the direction of Yₘₐₓ in comparison to the brightness of illuminated regions around the display, while achieving desirable security factor, Sₙ≥1.0 for an off-axis viewer 47 at the observation direction.

The above discussion focusses on reducing visibility of the displayed image to an off-axis viewer who is a snooper, but similar considerations apply to visibility of the displayed image to the intended user of the display device who is typically on-axis. In this case, decrease of the level of the visual security level (VSL) V corresponds to an increase in the visibility of the image to the viewer. During observation S<0.2 may provide acceptable visibility (perceived contrast ratio) of the displayed image and more desirably S<0.1. In practical display devices, this means that it is desirable to provide a value of S for an on-axis viewer who is the intended user of the display device that meets the relationship S≤Sₘₐₓ, where Sₘₐₓ has a value of 0.2.

The structure and operation of various switchable display devices will now be described. In this description, common elements have common reference numerals. It is noted that the disclosure relating to any element applies to each device in which the same or corresponding element is provided. Accordingly, for brevity such disclosure is not repeated.

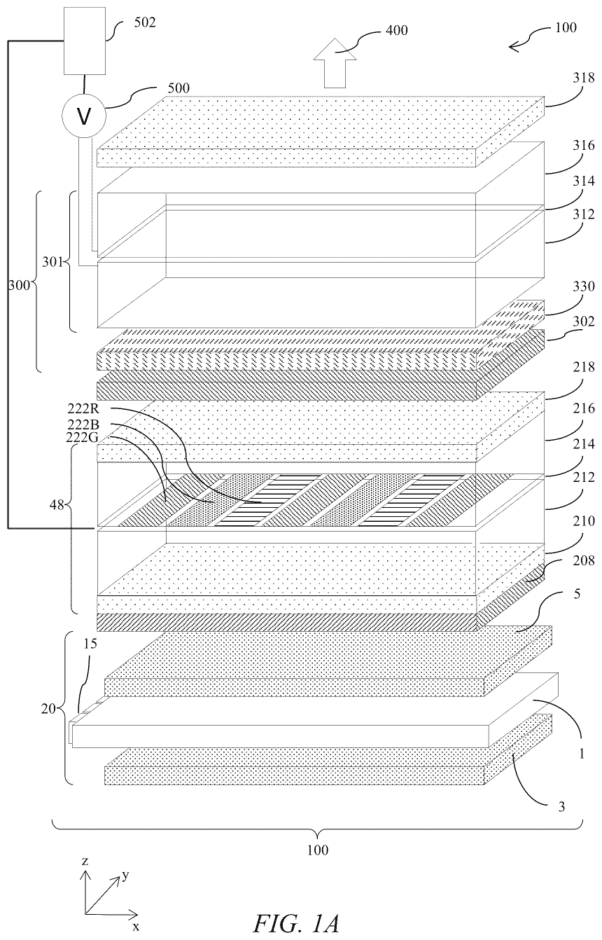

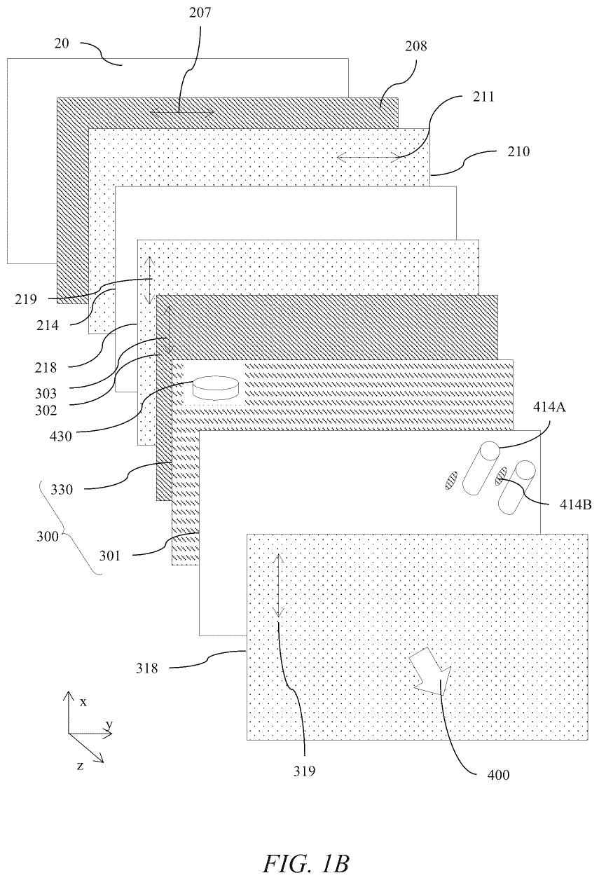

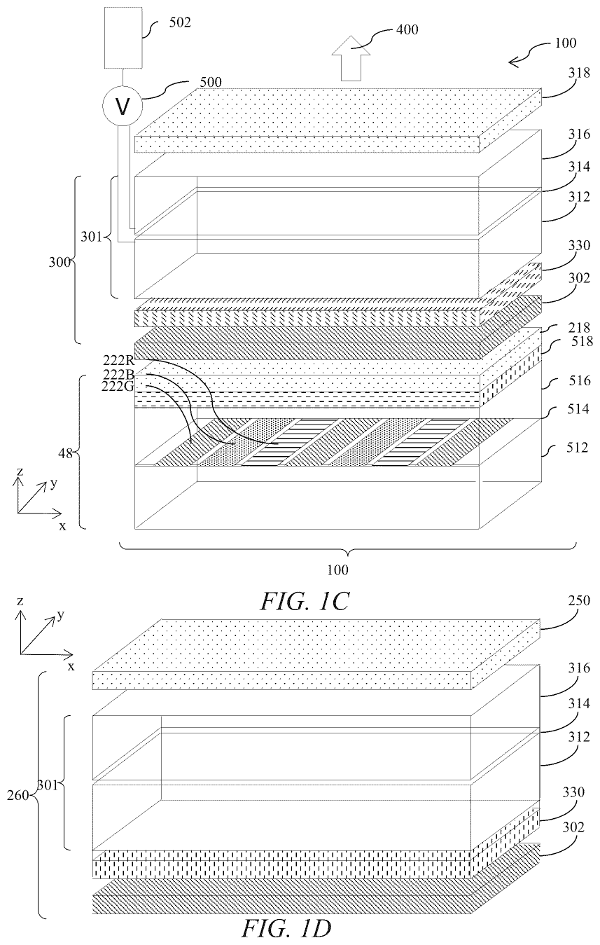

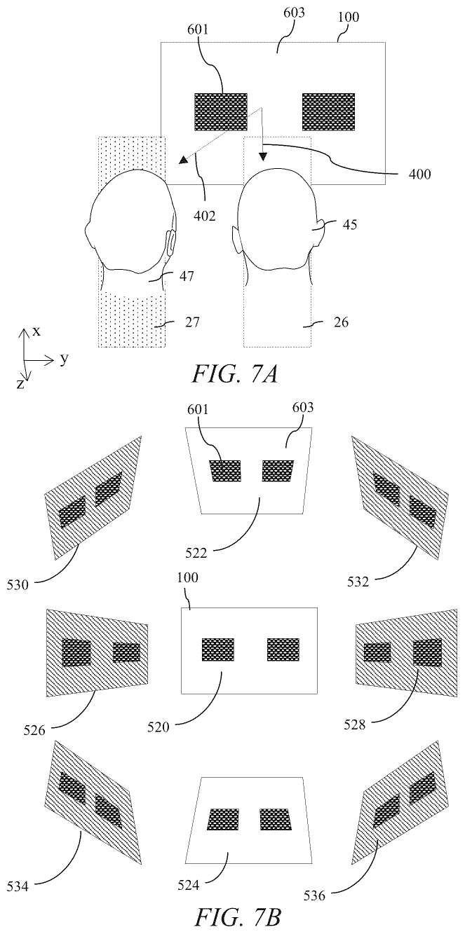

FIG. 1A is a schematic diagram illustrating in side perspective view an optical stack of a display device 100. The display device 100 may be termed a directional display device and may be arranged to provide viewing characteristics that vary with viewing angle of an observer 45 as described hereinbelow with respect to FIGS. 7A-B for example.

Display device 100 comprises a spatial light modulator 48 comprising at least one display polariser, that is the output polariser 218. The output polariser 218 is a linear polariser. Backlight 20 is arranged to output light and the spatial light modulator 48 comprises a transmissive spatial light modulator 48 arranged to receive output light from the backlight 20. The display device 100 is arranged to output light 400 with angular luminance properties as will be described herein.

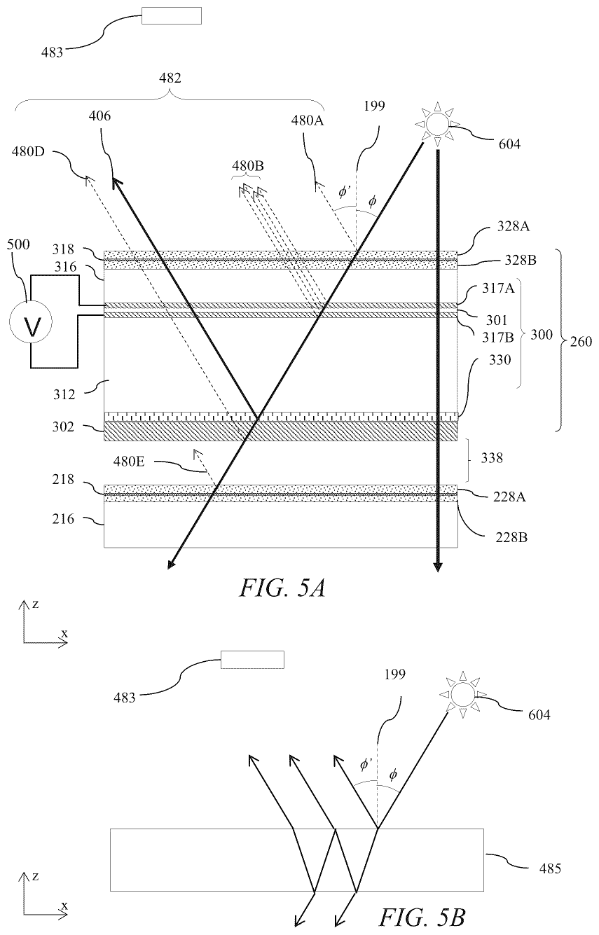

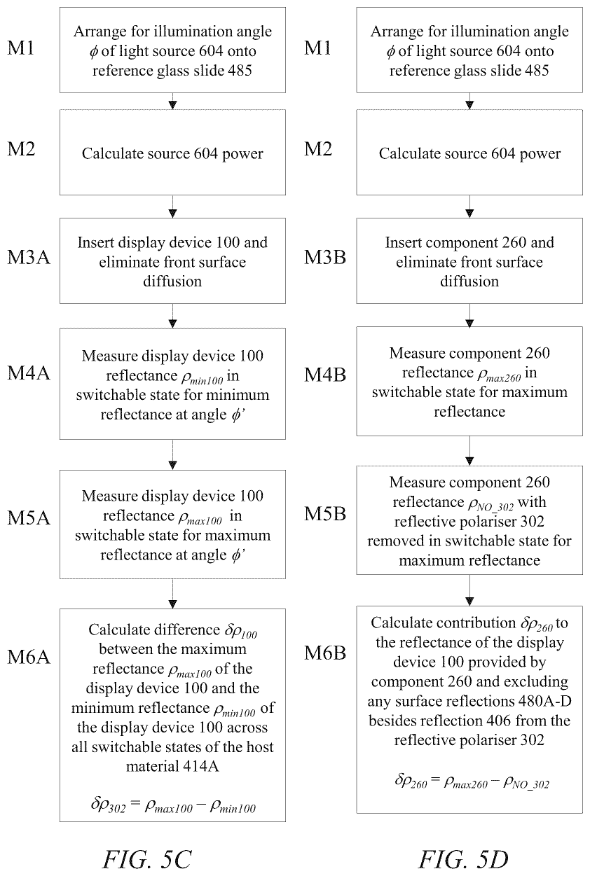

In the present disclosure, the spatial light modulator 48 may comprise a liquid crystal display comprising transparent substrates 212, 216, and pixel layer 214 having red, green and blue pixels 222R, 222G, 222B. The spatial light modulator 48 has an input display polariser 210 and an output display polariser 218 on opposite sides thereof. The output display polariser 218 is arranged to provide high extinction ratio for light from the pixels 222R, 222G, 222B of the spatial light modulator 48. The input display polariser 210 and the output display polariser 218 are each linear polarisers. Typical polarisers 210, 218, 318 may be linear absorbing polarisers such as stretched PVA iodine based polarisers that may be arranged between TAC layers 228, 328 as illustrated in FIG. 5A hereinbelow.

Optionally a reflective polariser 208 may be provided between the dichroic input display polariser 210 and backlight 20 to provide recirculated light and increase display efficiency. The reflective polariser 208 is arranged to improve the efficiency of the backlight 20 and in operation has a different function to the reflective polariser 302 described hereinbelow.

Backlight 20 may comprise input light sources 15, waveguide 1, rear reflector 3 and optical stack 5 comprising diffusers, light turning films and other known optical backlight structures. Asymmetric diffusers, that may comprise asymmetric surface relief features for example, may be provided in the optical stack 5 with increased diffusion in the elevation direction in comparison to the lateral direction may be provided. Advantageously image uniformity may be increased.

In the present embodiments, the backlight 20 may be arranged to provide an angular light distribution that has reduced luminance for off-axis viewing positions in comparison to head-on luminance. Backlight 20 may further comprise a switchable backlight arranged to switch the output angular luminance profile in order to provide reduced off-axis luminance in a privacy mode of operation and higher off-axis luminance in a wide-angle mode of operation. Such switching backlight 20 may cooperate with the switchable guest-host retarder 300 of the present embodiments.

A reflective polariser 302 is arranged on the output side of the display polariser 218, the reflective polariser 302 being a linear polariser, wherein the reflective polariser 302 and the display polariser 218 have electric vector transmission directions 303, 219 that are parallel.

Additional polariser 318 is arranged on the same output side of the spatial light modulator 48 as the display output polariser 218 and is arranged on the output side of the reflective polariser 302. The additional polariser 318 is a linear polariser and may be a linear absorbing polariser.

The display polariser 218 and the additional polariser 318 have electric vector transmission directions 219, 319 that are parallel. As will be described below, such parallel alignment provides high transmission for central viewing locations.

Plural retarders which together are referred to herein as a switchable guest-host retarder 300 are arranged between the reflective polariser 302 and the display polariser 218 and comprise: (i) a switchable guest-host liquid crystal retarder 301 comprising a liquid crystal layer 314 comprising a guest material and a host material arranged between the display polariser 218 and the additional polariser 318; and (ii) a passive compensation retarder 330. Thus at least one passive compensation retarder 330 is arranged between the reflective polariser 302 and the additional polariser 318.

FIG. 1B is a schematic diagram illustrating in front view alignment of optical layers in the display device 100 of FIG. 1A. Features of the embodiment of FIG. 1B not discussed in further detail may be assumed to correspond to the features with equivalent reference numerals as discussed above, including any potential variations in the features.

The input electric vector transmission direction 211 at the input display polariser 210 of the spatial light modulator 48 provides an input polarisation component that may be transformed by the pixel layer 214 to provide output polarisation component determined by the electric vector transmission direction 219 of the output display polariser 218. Pixels 222 are arranged at the layer 214 to provide switchable grey levels with a desirable contrast.

Passive compensation retarder 330 may comprise retardation layer with a discotic birefringent material 430, while switchable guest-host liquid crystal retarder 301 may comprise liquid crystal material.

Switchable guest-host retarder 300 thus comprises a switchable guest-host liquid crystal retarder 301 comprising a switchable guest-host liquid crystal layer 314, substrates 312, 316 and passive compensation retarder 330 arranged between an additional polariser 318 and display polariser 218.

Substrates 312, 316 may be glass substrates or polymer substrates such as polyimide substrates. Flexible substrates that may be conveniently provided with transparent electrodes may be provided. Advantageously curved, bent and foldable displays may be provided.

The display device 100 further comprises a control system 502 arranged to control the voltage applied by voltage driver 500 across the electrodes of the switchable guest-host liquid crystal retarder 301.

It may be desirable to provide reduced stray light or privacy control of an emissive display.

FIG. 1C is a schematic diagram illustrating in side perspective view an optical stack of a display device 100 comprising an emissive spatial light modulator 48 and a switchable guest-host retarder 300 arranged on the output side of the emissive spatial light modulator 48. Features of the embodiment of FIG. 1C not discussed in further detail may be assumed to correspond to the features with equivalent reference numerals as discussed above, including any potential variations in the features.

Spatial light modulator 48 may alternatively be provided by other display types that provide output light 400 by emission, such as organic LED displays (OLED) or inorganic micro-LED displays, with output display polariser 218, substrates 512, 516 and light emission layer 514. Output polariser 218 may provide reduction of luminance for light reflected from the OLED pixel plane by means of one of more retarders 518 inserted between the output display polariser 218 and pixel plane 214. The one or more retarders 518 may be a quarter waveplate and is different to the compensation retarder 330 of the present disclosure.

In the embodiment of FIG. 1C, the spatial light modulator 48 thus comprises an emissive spatial light modulator and the display polariser is output display polariser 218. Otherwise, the structure and operation of display device 100 of FIG. 1C is the same as that of FIG. 1A, as described above.

A view angle control optical element 260 for application to a display device will now be described. View angle control optical elements 260 may be added to spatial light modulators comprising a display polariser 210, 218 to achieve switchable field-of-view characteristics.

FIG. 1D is a schematic diagram illustrating in side perspective view a view angle control optical element 260 for application to a display device comprising a passive compensation retarder 330, a switchable guest-host liquid crystal retarder 301 and a control polariser 250. Features of the embodiment of FIG. 1D not discussed in further detail may be assumed to correspond to the features with equivalent reference numerals as discussed above, including any potential variations in the features.

In use, view angle control optical element 260 may be attached by a user or may be factory fitted to a polarised output spatial light modulator 48. View angle control optical element 260 may be provided as a flexible film for curved and bent displays. Alternatively the view angle control optical element 260 may be provided on a rigid substrate such as a glass substrate.

Advantageously, an after-market privacy control element and/or stray light control element may be provided that does not require matching to the panel pixel resolution to avoid Moiré artefacts. View angle control optical element 260 may be further provided for factory fitting to spatial light modulator 48.

By attaching the view angle control optical element 260 of FIG. 1D to a spatial light modulator 48, a display device 100 as shown in any of FIGS. 1A-C may be provided.

The embodiments of FIGS. 1A-D provide polar luminance control for light 400 that is output from the spatial light modulator 48. That is, the switchable guest-host retarder 300 (comprising the switchable guest-host liquid crystal retarder 301 and the passive compensation retarder 330) does not affect the luminance of light passing through the input display polariser 210, the switchable guest-host retarder 300 and the additional polariser 318 along an axis that is most typically, but not necessarily, along a normal to the plane of the switchable guest-host retarder 300 but the switchable guest-host retarder 300 does reduce the luminance of light passing therethrough along an axis inclined to said axis, at least in one of the switchable states of the compensated switchable retarder 300.

The principles leading to this effect arise from the presence or absence of a phase shift introduced by the switchable guest-host liquid crystal retarder 301 and the passive compensation retarder 330 to light along axes that are angled differently with respect to the liquid crystal material of the switchable guest-host liquid crystal retarder 301 and the passive compensation retarder 330. A similar effect is achieved in all the devices described below. The principles of the off-axis phase modification are described further in U.S. Pat. No. 11,092,851 (Atty. Ref. No. 412101), U.S. Pat. No. 10,976,578 (Atty. Ref. No. 413101), and U.S. Pat. No. 11,073,735 (Atty. Ref. No. 424001), all of which are herein incorporated by reference in their entireties.

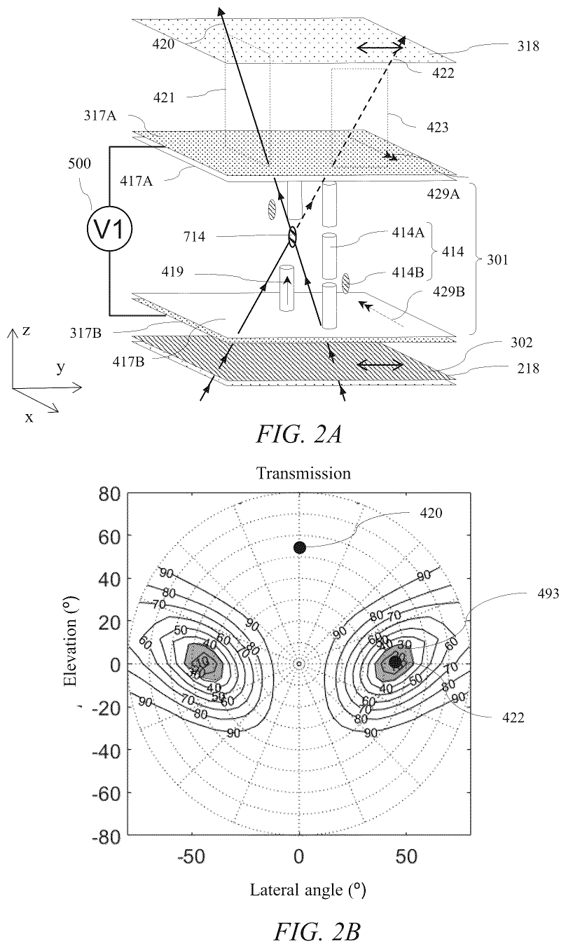

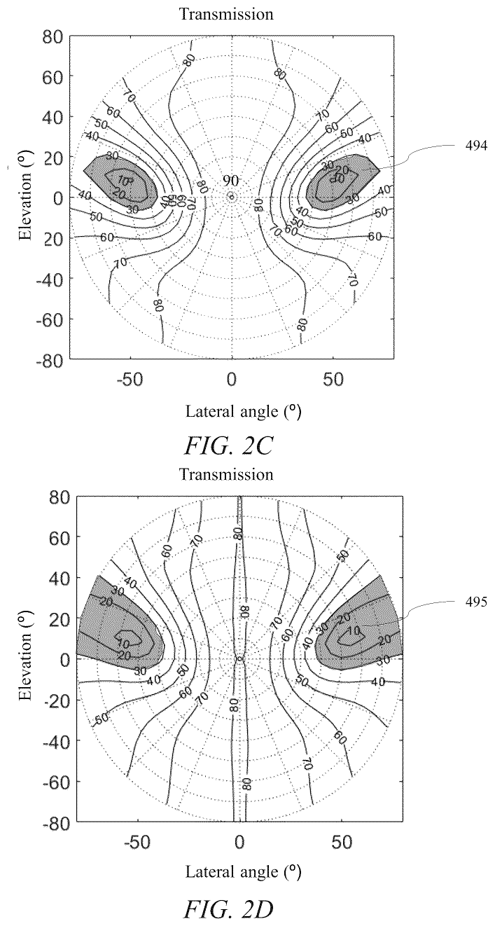

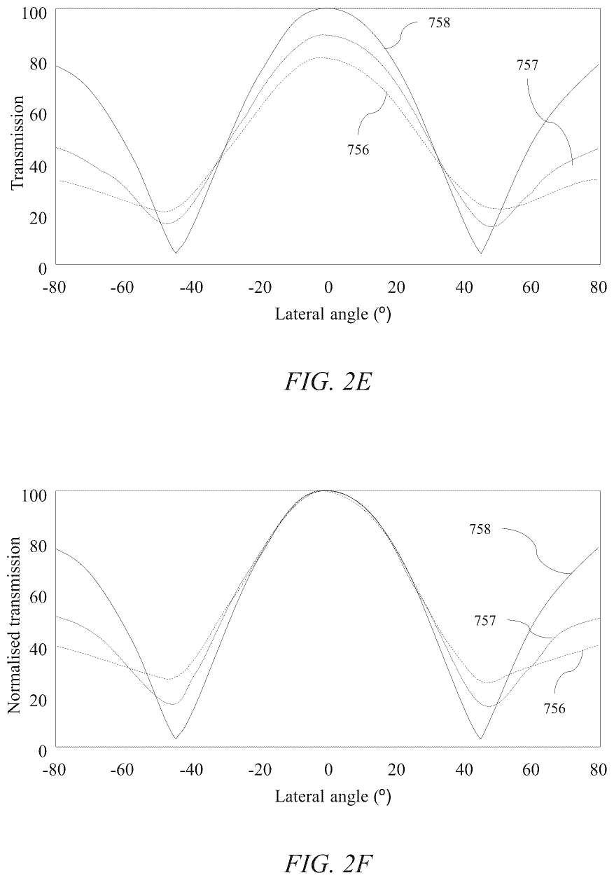

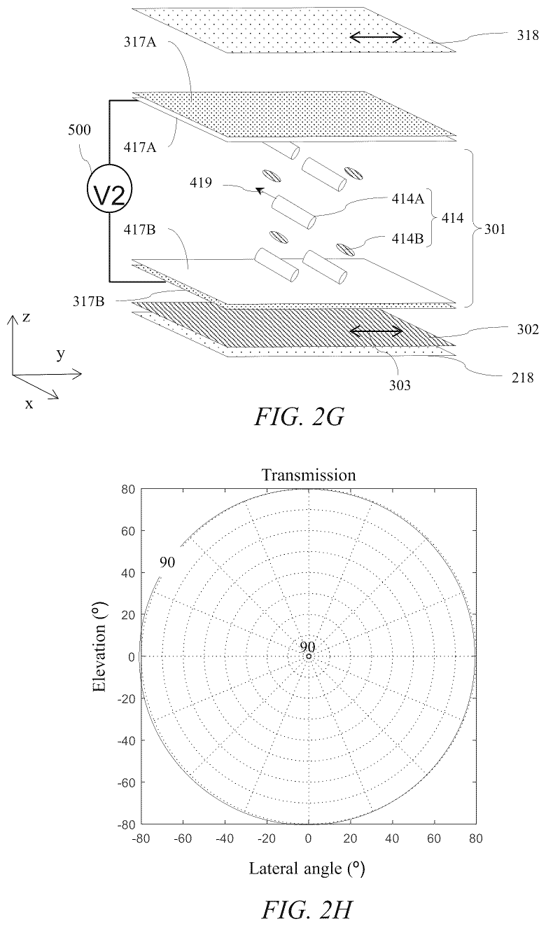

The operation of the guest-host liquid crystal retarder 301 will now be described with reference to the guest-host liquid crystal retarder 301 shown in FIG. 2A.

FIG. 2A is a schematic diagram illustrating in side perspective view a switchable guest-host liquid crystal retarder 301 in a privacy mode with a first drive voltage V1. Features of the embodiment of FIG. 2A not discussed in further detail may be assumed to correspond to the features with equivalent reference numerals as discussed above, including any potential variations in the features.

In FIG. 2A and other schematic diagrams below, some layers of the optical stack are omitted for clarity. For example the switchable guest-host liquid crystal retarder 301 is shown omitting the substrates 312, 316. By way of comparison with FIG. 1A, in the alternative embodiment of FIG. 2A the passive compensation retarder 330 is omitted.

The guest-host liquid crystal retarder 301 comprises a liquid crystal layer 314 comprising a guest material 414B and a host material 414A, wherein the guest material 414B is an anisotropic material and the host material 414A is a liquid crystal material, the guest-host liquid crystal retarder 301 being arranged on the same side of the spatial light modulator 48 as the display polariser 218 with the display polariser 218 arranged between the guest-host liquid crystal retarder 301 and the spatial light modulator 48, wherein in at least one switchable state of the host material 414A, the optical axis of the guest-host liquid crystal retarder 301 has an alignment component perpendicular 419 to the plane of the guest-host liquid crystal retarder 301 in at least a state of the host material 414A.

Guest material 414B may be a dichroic dye or pleochroic dye and typically may be a positive dichroic dye, with absorption of polarisation state that is parallel to the long axis of the dichroic guest material 414B.

The guest-host liquid crystal retarder 301 further comprises a first transparent electrode 317A and first alignment layer 417A with alignment direction 429A arranged on a side of the layer of liquid crystal material 414, and a second alignment layer 417B with alignment direction 429B and second transparent electrode 317B arranged on the opposite side of the layer of liquid crystal material 414. The guest-host liquid crystal retarder 301 is a switchable liquid crystal retarder further comprising transparent electrodes 317A, 317B arranged to apply a voltage capable of switching the host material 414A between different states. The states may be provided by control system 500 to provide share mode, privacy mode or low stray light modes of operation. Intermediate states may be provided to achieve modification of the location and security factor of desirable luminance profiles.

Transparent electrodes 317A, 317B such as ITO electrodes are arranged on opposite sides of the switchable guest-host liquid crystal retarder 301. Electrodes 317A, 317B control the switchable guest-host liquid crystal retarder 301 by adjusting the voltage being applied by the electrodes 317A, 317B to the guest-host liquid crystal retarder 301. The applied voltage is capable of switching host material between at least two states, in one of which states the optical axis of the guest-host liquid crystal retarder has an alignment component 419 perpendicular to the plane of the guest-host liquid crystal retarder 301. Control system 502 is arranged to control the voltage applied by voltage driver 500 across the electrodes 317A, 317B of the switchable guest-host liquid crystal retarder 301.

The dichroic dye 414B is oriented by the aligned liquid crystal material 414A. As illustrated in FIG. 2A, when voltage V1 is applied across electrodes 417A, 417B providing an alignment state of the retarder 301, the optical axis direction of the guest-host liquid crystal retarder 301 has an alignment component 419 perpendicular to the plane of the retarder 301.

In operation light ray 420 that is propagating in the x-z plane 421 has a linear polarisation component imparted by display polariser 218. Such polarisation component is incident on a molecule 714 of the guest material 414B at an orientation that is orthogonal to the absorption axis of the molecule 714. Thus light rays 420 in the elevation direction are substantially transmitted.

By way of comparison light ray 422 that is propagating in the y-z plane 423 has a polarisation component that is parallel to the absorption axis of the dichroic dye molecule 714, and thus undergoes some absorption. Thus light rays 420 in the lateral direction are substantially transmitted.

FIG. 2B illustrates the polar transmission profile that arises from the difference in transmission of rays such as rays 420, 422.

Desirable ranges for guest-host materials have been established by means of simulation of retarder stacks and experiment with display optical stacks.

FIGS. 2B-D are schematic graphs illustrating the variation of output transmission with polar direction for the transmitted light rays in FIG. 2A for the illustrative embodiments of TABLE 1 with 0%, 0.5% and 1.0% dye concentrations of guest dichroic dye material respectively; FIG. 2E is a schematic graph illustrating the simulated variation of output transmission with lateral angle at zero elevation with the varying concentration of dichroic dye for the transmitted light rays in FIG. 2A and TABLE 1; and FIG. 2F is a schematic graph illustrating the simulated variation of normalised output transmission with lateral angle at zero elevation with varying concentration of dichroic dye for the transmitted light rays in FIG. 2A with the parameters described in TABLE 1. Features of the embodiments of FIGS. 2B-F not discussed in further detail may be assumed to correspond to the features with equivalent reference numerals as discussed above, including any potential variations in the features.

TABLE 1

| | | Passive compensation retarder(s) | | Guest-host liquid crystal retarder | | | | |
|---|---|---|---|---|---|---|---|---|
| | | | Δn.d/ | Order | Guest-host | LC tilt/ | Δn.d/ | Additional |
| FIGS. | Mode | Type | nm | parameter | concentration | deg | nm | polariser |
| 2B & 2E-F | Privacy | None | 0 | 0.8 | 0% | 65 | 810 | Yes |
| profile 758 | | | | | | | | |
| 2C & 2E-F | | | | | 0.5% | | | |
| profile 757 | | | | | | | | |
| 2D & 2E-F | | | | | 1.0% | | | |
| profile 756 | | | | | | | | |

FIGS. 2C-F illustrate that as the guest-host concentration is increased, the head-on luminance reduces, as a consequence of the order parameter of the liquid crystal molecules limiting the alignment to the polariser 218 of the absorbing dichroic dye molecules that can be achieved.

Advantageously, reduced off-axis luminance can be achieved, providing increased privacy performance.

Considering FIG. 2B, the size of the polar region over which the polar control retarder 300 and additional polariser 318 with no guest material 414B has transmission below 30% is illustrated by polar region 493; in FIG. 2C the size of the polar region over which the polar control retarder 300 and additional polariser 318 with 1% guest material 414B has transmission below 30% is illustrated by polar region 494; and in FIG. 2D the size of the polar region over which the polar control retarder 300 and additional polariser 318 with 1% guest material 414B has transmission below 30% is illustrated by polar region 495. The size of the polar region 495 is increased in comparison to the size of the polar region 493 and particularly is increased at higher lateral angles by the addition of the guest material 414B.

In order to achieve desirable off-axis luminance reduction while minimising absorption, the volume of the guest material may comprise less than 3%, preferably less than 2% and most preferably less than 1% of the volume of the host material. Alternatively, in order to achieve desirable off-axis luminance reduction while minimising absorption, the weight of the guest material may comprise less than 3%, preferably less than 2% and most preferably less than 1% of the weight of the host material. Advantageously reducing the guest concentration provides increased efficiency in the direction normal to the retarder 301 while providing some off-axis luminance reduction.

The on-axis extinction coefficient of the guest-host liquid crystal retarder 301 may be determined by aligning the retarder 301 to a linear absorbing polariser that has an electric vector transmission direction that is (i) perpendicular and (ii) parallel with the absorption axis of the retarder 301. The extinction coefficient is the ratio of the measurements for the perpendicular and parallel orientations. The on-axis extinction coefficient of the guest-host liquid retarder 301 in at least one state of operation is at least 60%, preferably at least 80% and most preferably at least 90%.

Alternatively or additionally to the absorbing dichroic materials described, the anisotropic material 414B may comprise metallic nanomaterials that may be nanowires, nanorods, nanoplatelets or other nanoscale anisotropic particles.

In comparison to the absorbing dichroic materials described elsewhere, the nanoparticles may provide some reflective properties that are polarisation dependent, in a similar manner to wire grid polarisers, although with homeotropic alignment introduced by the liquid crystal alignment. In particular the complex refractive index of the layer may provide the effect of a bulk specular reflector for a first polarisation component 480 and transmit the orthogonal polarisation component 482. On-axis incident light rays 400 may be transmitted by the guest-host liquid crystal material 414A, 414B for both polarisation components 480, 482 but off-axis light rays 401 may be reflected for polarisation component 480.

The metallic nanowires 414B may further comprise an electrically insulating and optically transparent surface layer 474 that prevents an electrical path between the electrodes 317A, 317B. This may be achieved by chemical treatment or processing so that an optically transparent electrically insulating coating or layer 474 is present on all or just the end part of the nanowires. The chemical treatment or processing may for example comprise oxidation of nanowires, which may be aluminium. This achieves off-axis reflection from metal nanowires with essentially no DC electrical conductivity path within the liquid crystal material 414.

Further the silver nanowires provide reflection of light rays 401 from ambient light source 604.

Ambient reflections increase the perceived background level of the image as seen by an observer and thus reduce perceived image contrast. Advantageously privacy performance is increased.

In comparison to the output of FIG. 2B, FIGS. 2C-D illustrate that the dichroic dye 414B advantageously reduces the visibility of the ‘bulls-eye’ structure and increases the angular field of view over which privacy performance is maintained.

Share mode, or wide-angle mode of operation will now be considered.

FIG. 2G is a schematic diagram illustrating in side perspective view a switchable guest-host liquid crystal retarder 301 in a wide-angle mode with a second drive voltage V2 that is zero volts; and FIG. 2H is a schematic graph illustrating the variation of output transmission with polar direction for the transmitted light rays in FIG. 2G. Features of the embodiments of FIGS. 2G-H not discussed in further detail may be assumed to correspond to the features with equivalent reference numerals as discussed above, including any potential variations in the features.

In the alternative embodiment of FIG. 2A and FIG. 2G, alignment layers 417A, 417B provide homogeneous alignment of the layer of liquid crystal material 414 near the respective alignment layers 417A, 417B. In the share mode arrangement of FIG. 2G and TABLE 1 the voltage V2 is zero and the liquid crystal molecules of the guest material 414B are in-plane through the thickness of the guest-host liquid crystal retarder 301. The polarisation state transmitted by the display polariser 218 and reflective polariser 302 does not align with the absorption axis of the molecules 714.

The guest material 414B comprises a positive dichroic guest material or a positive pleochroic material and the optical axis of the guest-host liquid crystal layer has an alignment component 419 in the plane of the guest-host liquid crystal layer 301 that is orthogonal to the electric vector transmission directions 219, 303 of the display polariser 218 and reflective polariser 302. Thus the transmission axis of the host material 414B is aligned to the transmission axis of the linear absorbing polariser 218. The field of the view of the input light is substantially unmodified by the dichroic guest material 414B. Advantageously a wide-angle mode may be provided.

It would be desirable to further reduce the off-axis visibility of the display in privacy mode while maintaining wide-angle operation.

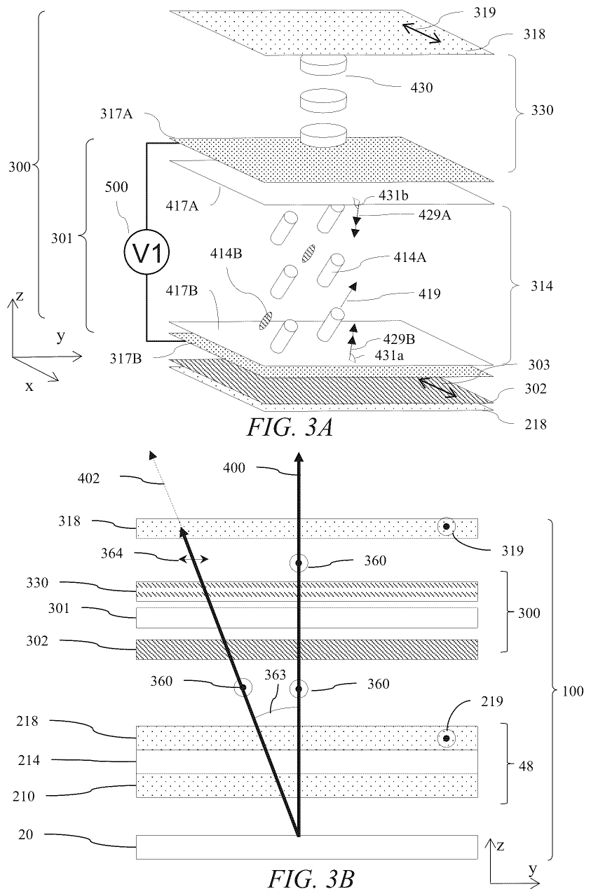

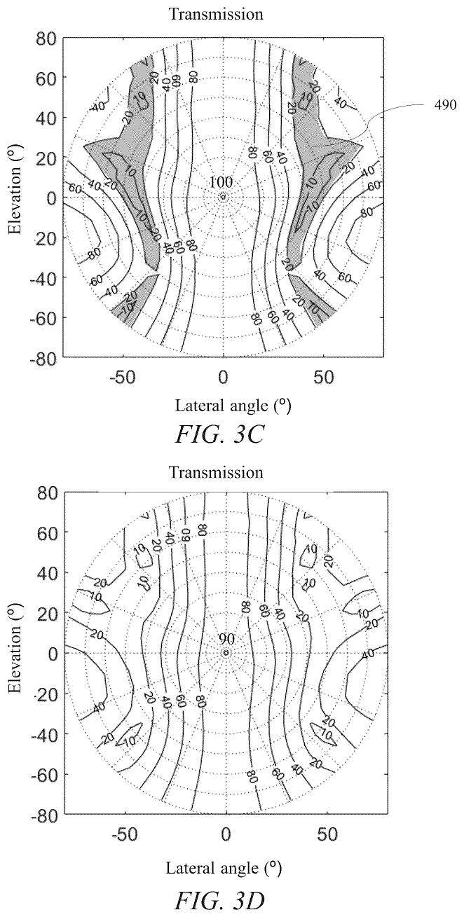

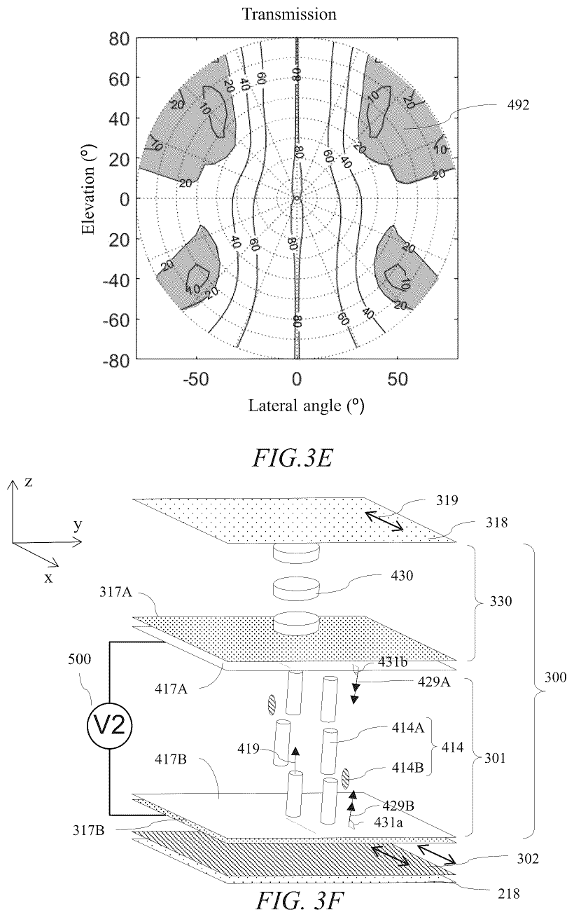

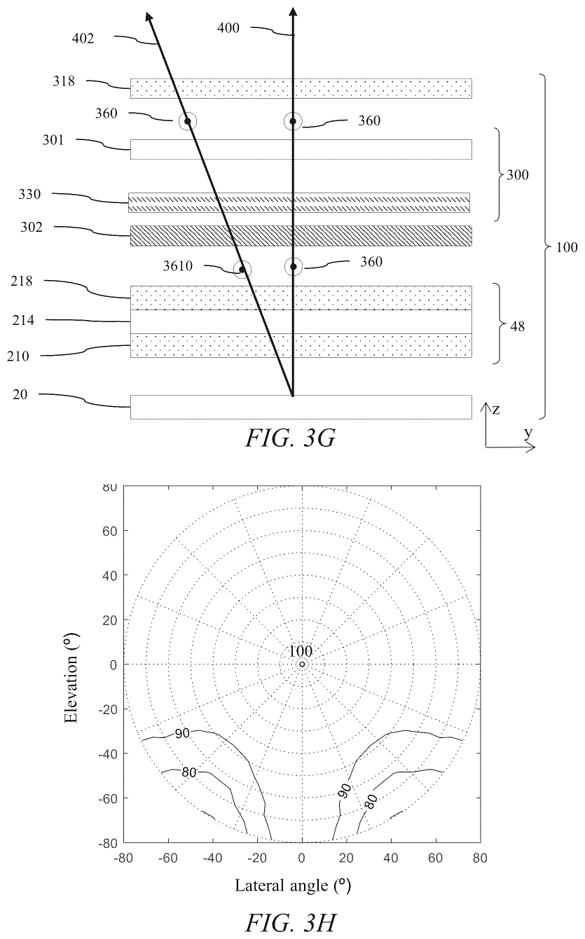

FIG. 3A is a schematic diagram illustrating in perspective side view a switchable compensated guest-host liquid crystal retarder 301 comprising a negative C-plate passive compensation retarder and driven in a privacy mode; and FIG. 3B is a schematic diagram illustrating in side view propagation of transmitted light from the spatial light modulator 48 through the optical stack of FIG. 3A in a privacy mode wherein the switchable guest-host liquid crystal retarder 301 is oriented by means of an applied voltage V1. Features of the embodiments of FIGS. 3A-B not discussed in further detail may be assumed to correspond to the features with equivalent reference numerals as discussed above, including any potential variations in the features.

By way of comparison to FIG. 2A, in the alternative embodiment of FIGS. 3A-B, the polar control retarder 300 further comprises an additional compensation retarder 330.

The passive compensation retarder 330 comprises a negative C-plate retarder having an optical axis that is a fast axis perpendicular to the plane of the retarder. Thus the material 430 of the C-plate retarder may have a negative dielectric anisotropy. C-plates may comprise transparent birefringent materials such as: polycarbonates or reactive mesogens that are cast onto a substrate that provides homeotropic alignment for example; Zeonex™ Cyclo Olefin Polymer (COP); discotic polymers; and Nitto Denko double stretched polycarbonates.

Such arrangements not incorporating dye materials 414B are illustrated in U.S. Pat. No. 11,092,851 (Atty. Ref. No. 412101), which is herein incorporated by reference in its entirety.

Alignment layers 417A, 417B provide homeotropic alignment, that is the pretilt angles 431a, 431b are close to 90°, for example 88°, with a component of pretilt in the direction parallel to the electric vector transmission direction 303 and the liquid crystal material 414A has a negative dielectric anisotropy.

When a voltage V1 is applied to the guest-host liquid crystal retarder 301, the molecules of the liquid crystal material 414A are aligned with a tilt that provides a phase difference of the input polarisation state 303 of light from the spatial light modulator 48 through the reflective polariser 302.

In the present embodiments, the compensated switchable liquid crystal retarder 330 may be configured, in combination with the display polariser 218, reflective polariser 302 and the additional polariser 318, to have the effect that the luminance of light output from the display device 100 at an acute angle 363 to the optical axis (off-axis) is reduced. The compensated switchable liquid crystal retarder 300 may also be configured to have the effect that the luminance of light output from the display device 100 along an axis illustrated by the ray 400 is the same for all applied voltages across the liquid crystal retarder 301.

The direction of ray 400 may be normal to the layer of liquid crystal material 414 or may be inclined to the normal. Inclined direction of ray 414 may be arranged by a rotation in the plane of the alignment layer 417B of alignment layers 417A, 417B of at least one of the alignment directions 429A, 429B. Non-normal directions for ray 400 are further described in U.S. Pat. No. 11,079,646 (Atty. Ref. No. 419001), which is herein incorporated by reference in its entirety. Advantageously preferable user 45 viewing directions may be provided for non-central viewing directions such as in automotive vehicles.

In operation, polarisation component 360 from the output display polariser 218 is transmitted by output display polariser 218 and incident on switchable guest-host polar control retarder 300. On-axis light ray 400 has a polarisation component 360 that is unmodified while off-axis light ray 402 has a polarisation component 364 that is transformed by retarders of switchable guest-host retarder 300. At a minimum of transmission, the polarisation component 364 is transformed to a linear polarisation component that is absorbed by additional polariser 318. More generally, the polarisation component 360 at angles 363 is transformed to an elliptical polarisation component, and is partially absorbed by additional polariser 318. An illustrative embodiment will now be described for narrow angle operation.

FIG. 3C, FIG. 3D and FIG. 3E are schematic graphs illustrating the variation of output transmission with polar direction for the transmitted light rays in FIGS. 3A-B, with the parameters described in TABLE 2. Features of the embodiments of FIGS. 3C-E not discussed in further detail may be assumed to correspond to the features with equivalent reference numerals as discussed above, including any potential variations in the features.

TABLE 2

| | | Passive compensation retarder(s) | | Guest-host liquid crystal retarder | | | | |
|---|---|---|---|---|---|---|---|---|
| | | | Δn.d/ | Order | Guest-host | LC tilt/ | Δn.d/ | Additional |
| FIG. | Mode | Type | nm | parameter | concentration | deg | nm | polariser |
| 3C | Privacy | Negative C | −700 | 0.8 | 0% | 65 | 810 | Yes |
| 3D | | | | | 0.5% | | | |
| 3E | | | | | 1.0% | | | |
| 3H | Wide | | | | 0.0% | 0 | | |

In the present embodiments, desirable ranges for retardations and voltages have been established by means of simulation of retarder stacks and experiment with display optical stacks.

In the illustrative example of TABLE 2, the switchable liquid crystal retarder 300 comprises a first surface alignment layer 417A disposed on a first side of the layer of liquid crystal material 414, and a second surface alignment layer 417B disposed on the second side of the layer of liquid crystal material 414 opposite the first side; wherein the first surface alignment layer 417A is a homeotropic alignment layer and the second surface alignment layer 417B is a homeotropic alignment layer, wherein the layer of liquid crystal material has a retardance for light of a wavelength of 550 nm between 500 nm and 1000 nm, preferably between 600 nm and 900 nm and most preferably between 700 nm and 850 nm.

When the passive compensation retarder 330 comprises a C-plate retarder having an optical axis perpendicular to the plane of the retarder, the passive retarder has a retardance for light of a wavelength of 550 nm between-300 nm and −900 nm, preferably between-450 nm and −800 nm and most preferably between −500 nm and −725 nm.

In comparison to the output of FIG. 2B the polar distribution of light transmission illustrated in FIG. 3C modifies the polar distribution of luminance output from the underlying spatial light modulator 48.

Considering now the addition of guest dichroic dye material 414B, in comparison to the output of FIG. 3C the profiles of FIGS. 3D-E provides increased luminance reduction over a wider field of view. Advantageously off-axis luminance may be further reduced. A privacy display is provided that has low luminance to an off-axis snooper while maintaining high luminance for an on-axis observer. A large polar region is provided over which the luminance of the display to an off-axis snooper is reduced. Further the on-axis luminance is substantially unaffected for the primary display user in privacy mode.

The voltage applied across the electrodes is zero for a first orientation state and non-zero for a second orientation state. Advantageously the wide mode of operation may have no additional power consumption, and the failure mode for driving of the switchable guest-host liquid crystal retarder 301 is for wide-angle mode.

In the further exemplary embodiments described below comprising guest-host liquid crystal retarders 301, such guest material may serve to further reduce off-axis luminance in privacy mode while having a reduced effect on the wide-angle mode field of view, advantageously achieving improved privacy performance and improved share mode performance.

Share mode of operation of the embodiment of FIG. 3A will now be described.

FIG. 3F is a schematic diagram illustrating in perspective side view an arrangement of the switchable guest-host retarder 300 in a wide-angle mode; FIG. 3G is a schematic diagram illustrating in side view propagation of output light from the spatial light modulator 48 through the optical stack of FIG. 3F in a wide-angle mode; and FIG. 3H is a schematic graph illustrating the variation of output transmission with polar direction for the transmitted light rays in FIG. 3G in a wide-angle mode. Features of the embodiment of FIGS. 3F-H not discussed in further detail may be assumed to correspond to the features with equivalent reference numerals as discussed above, including any potential variations in the features.

By way of comparison with FIG. 3A, in FIG. 3F the voltage V2 is zero volts and the liquid crystal material 414A aligns by the alignment direction 429A, 429B of the alignment layers 417A, 417B respectively. When the switchable guest-host liquid crystal retarder 301 is in the second orientation state of said two orientation states, the plural retarders 301, 330 provides small overall retardance to light passing therethrough along an axis of rays 400, 402 so that the output of FIG. 3H has somewhat uniform transmission with viewing angle.

The present embodiments achieve substantially similar off-axis luminance reductions due to the bulk retardance properties of the host liquid crystal material 414A. Further the off-axis luminance reductions due to the aligned guest dye materials 414B are provided in such embodiments. Advantageously off-axis luminance may be further reduced.

An ideal compensated switchable retarder 300 comprises compensation retarder 330 in combination with a variable switchable guest-host liquid crystal retarder 301 wherein the dielectric constants, anisotropy and dispersion of anisotropy of the compensation retarder 330 have the equal and opposite dielectric constants, anisotropy and dispersion of anisotropy to that of the layer 314. The retardance of the passive compensation retarder 330 is equal and opposite to the retardance of the switchable guest-host liquid crystal retarder 301.

Such an ideal compensated switchable retarder achieves compensation for transmitted light in a first wide-angle state of the layer 314 of liquid crystal material 414 for all polar angles; and narrow field of view in a lateral direction in a second privacy state of the switchable guest-host liquid crystal retarder 301.

Further the optical axis of compensation retarder 330 has the same direction as that of the optical axis of the guest-host liquid crystal retarder 301 in its wide-angle state. Such a compensation retarder 330 cancels out the retardation of the liquid crystal retarder for all viewing angles, and provides an ideal wide-angle viewing state with no loss of luminance for all viewing directions.

The wide-angle transmission polar profile for non-ideal material selections will now be described.

The illustrative embodiments of the present disclosure illustrate compensation retarders 330 that may not exactly compensate the retardation of the switchable guest-host liquid crystal retarder 301 because of small differences in material properties that are typical for the retarders 330, 301. However, advantageously such deviations are small and high performance wide and narrow angle states can be achieved with such deviations that may be close to ideal performance.

In other words, when the layer of liquid crystal material 414 is in the first orientation state of said two orientation states, the plural retarders 330, 301 provide no overall retardance to light passing therethrough perpendicular to the plane of the retarders or at an acute angle to the perpendicular to the plane of the retarders 330, 301.

Advantageously the variation of display luminance with viewing angle in the first state is substantially unmodified. Multiple users may conveniently view the display from a wide range of viewing angles.

Further the wide-angle profile of FIG. 3H is provided with similarly wide angle due to the action of the guest dichroic material 414B. Thus the wide-angle mode performance may be substantially unmodified by the dichroic material 414B, other than the overall transmission being modified by the order parameter of the material 414B as described hereinabove. Advantageously a display that can be observed from a large field of view may be provided.

The operation of the reflective polariser 302 for light from ambient light source 604 will now be described for the display operating in privacy mode.

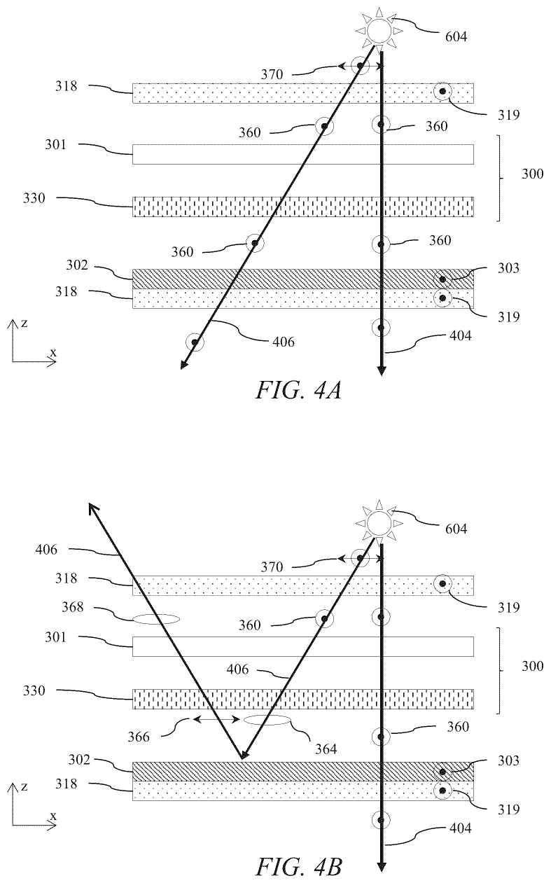

FIG. 4A is a schematic diagram illustrating in top view propagation of ambient illumination light 604 through the optical stack of FIG. 1A in a share mode; and FIG. 4B is a schematic diagram illustrating in top view propagation of ambient illumination light through the optical stack of FIG. 1A in a privacy mode. Features of the embodiment of FIGS. 4A-B not discussed in further detail may be assumed to correspond to the features with equivalent reference numerals as discussed above, including any potential variations in the features.

Ambient light source 604 illuminates the display device 100 with unpolarised light state 370. Additional polariser 318 transmits light ray 404 normal to the display device 100 with a first polarisation component 360 that is a linear polarisation component parallel to the electric vector transmission direction 319 of the additional polariser 318. Considering ray 404 that may be in the opposite direction to the ray 400 of FIG. 3A for example, in both states of operation, the polarisation component 360 does not change polarisation state after transmission through the retarders 300 and so transmitted polarisation component 360 is parallel to the transmission axis of the reflective polariser 302 and the output polariser 218, so ambient light is directed through the spatial light modulator 48 and lost by absorption and scattering.

Considering off-axis ray 406 in the share mode operation of FIG. 4A, again the polarisation component 360 does not substantially change polarisation state after transmission through the retarders 300 and so transmitted polarisation component 360 is parallel to the transmission axis of the reflective polariser 302 and the output polariser 218, so ambient light is directed through the spatial light modulator 48 and lost. The reflectance of the display device 100 is thus not increased in either on-axis or off-axis directions when the display device 100 is operating in share mode. Advantageously high image visibility may be provided.

By comparison, in privacy mode as illustrated in FIG. 4B, for off-axis ray 406, light is directed through the retarders 300 such that polarisation component 364 incident on the reflective polariser 302 has a polarisation component 366 that is orthogonal to the electric vector transmission direction 303 of the reflective polariser 302 and said polarisation component 366 is reflected. Such polarisation component 366 is converted into component 368 after passing through the polar control retarder 300 and at least some light is transmitted through the additional polariser 318.

Thus when the layer of liquid crystal material 414 is in the privacy mode, the reflective polariser 302 provides no reflected light for ambient light rays 404 passing through the additional polariser 318 and then the retarders 300 along an axis that may for example be perpendicular to the plane of the retarders 300 as illustrated by ray 404 but not limited to perpendicular. The reflective polariser 302 does provide reflected light rays 406 for ambient light passing through the additional polariser 318 and then the retarders 300 at some polar angles which are at an acute angle to the axis, wherein the reflected light 406 passes back through the retarders 300 and is then transmitted by the additional polariser 318.

Display device 100 reflectance can be provided at typical snooper 47 locations by means of the privacy mode of the retarders 300. Thus, in the privacy mode, the reflectance for off-axis viewing positions is increased to achieve increased security factor. The luminance for off-axis light from the spatial light modulator is reduced as illustrated in FIG. 3B.

Contributions to display device 100 reflectance will now be described.

FIG. 5A is a schematic diagram illustrating in top view propagation of reflected light from components arranged on the front side of display device 100; FIG. 5B is a schematic diagram illustrating in top view a measurement method to determine the brightness of a light source at a measurement angle ϕ; and FIGS. 5C-D are flow charts illustrating methods for the measurement of display device reflectance. Features of the embodiments of FIG. 5A-D not discussed in further detail may be assumed to correspond to the features with equivalent reference numerals as discussed above, including any potential variations in the features.

Polariser 318 is arranged between protective layers 328A, 328B, which may for example be TAC polymer layers. Protective layers may optionally include colourless polyimide or ultra-thin glass (not shown). A touch panel may optionally be provided (not shown). These surfaces may be provided with anti-reflection coatings. Polariser 218 is arranged between protective layers 228A, 228B which may for example be TAC polymer layers. Air gap 338 is illustrated between the reflective polariser 302 and the protective layer 228A.

FIG. 5A illustrates part of the display device 100 with some layers omitted and illustrates the primary light reflecting layers, with reflected rays 480A from the outer surface of protective layer 328A; reflected rays 480B from the transparent electrodes 317A, 317B, reflected ray 406 from the reflective polariser 302 as described in FIG. 4B; and reflected rays 480D, 480E that may be present at the air gap 338. In an alternative embodiment the air gap 338 may be replaced by an optically clear bonding material that substantially eliminates the rays 480D, 480E.

In operation, the rays 480A-E provide a base level of display reflectance that in an illustrative embodiment may for example be 8% at a lateral angle ϕ of 45°. Such base level of display reflectance has an angular dependence due to Fresnel reflection coefficients and is typically dominated by the luminance of the reflected rays 480A, in the absence of anti-reflection coating of protective layer 328A

In the present disclosure, the reflectance of the surface of a material is its effectiveness in reflecting radiant energy and is the fraction of incident electromagnetic power that is reflected at the boundary. Reflectance may be measured as a ratio of input photopic power to reflected photopic power in a given direction. The additional polariser 318, polar control retarder 300 and reflective polariser 302 together contribute to the overall reflectance.

The reflectance of the light ray 406 may be approximated to a first order using eqn. 11 where ρ₃₀₁ is the reflectance due to the additional polariser 318; polar control retarder 300 comprising guest-host liquid crystal retarder 301 and reflective polariser 302; τ₃₁₈ is the transmission of the additional polariser 318; τ₃₁₇ is the transmission of the transmissive electrodes 317A, 317B; τ_{301A} is the transmission of the ray 406 through the layer of guest-host liquid crystal retarder 301 that would be reflected by the reflective polariser 302 without absorption, that is the transmission of the liquid crystal retarder 301 if the guest-host material were not provided, for example as illustrated in FIG. 3C; γ_{301B} is the absorption of the guest material 404B of the ray 406 through the layer of guest-host liquid crystal retarder 301 and ρ₃₀₂ is the reflectance of reflective polariser 302.

$${ρ}_{301} \sim 0.5 . {τ}_{318}^{2} . {τ}_{317}^{4} . {( 1 - {τ}_{301 A} )}^{2} . {( 1 - {γ}_{301 B} )}^{2} . {ρ}_{302} \qquad eqn . 11$$

Considering again eqn. 10, the display device 100 has a security factor of S₁₀₀ in a given polar direction for an illustrative display that has a privacy level of P₁₀₀ (representing the relative luminance in the polar direction compared to the peak luminance of the display device 100) and for an illuminance that is reflected in the polar direction measured in lux that is the same as the peak luminance measured in nits (i.e. α=1 lux/nit) of:

$${S}_{100} = {log}_{10} ( 1 + {ρ}_{100} / ( π . {P}_{100} ) ) \qquad eqn . 12$$

Illustrative stacks are shown in TABLE 3, wherein Stack (1) comprises no guest material 414B, Stack (2) is an illustrative embodiment of the present disclosure; Stack (3) comprises no reflective polariser 302; and each of the three stacks illustrates the direction of peak security factor.

TABLE 3

| | Guest-host | | | | | | | | | | S₁₀₀ @ |
|---|---|---|---|---|---|---|---|---|---|---|---|
| Stack | concentration | ϕ | τ₃₁₈ | τ₃₁₇ | τ_{301A} | γ_{301B} | ρ₃₀₂ | ρ₃₀₁ | ρ₁₀₀ | P₁₀₀ | 1 lux/nit |
| (1) | 0% | 45° | 90% | 95% | 10% | 0 | 99% | 26% | 34% | 0.5% | 1.4 |
| (2) | 1% | | | | | 50% | | 7% | 15% | 0.25% | 1.0 |
| (3) | 1% | | | | | 50% | 0% | 0% | 8% | 0.25% | 0.8 |

It would be desirable to maximise the security factor, S₁₀₀. In typical illumination environments when a is 1 lux/nit then TABLE 3 illustrates that Stack (1) is a preferable arrangement to the embodiment of Stack (2). By way of comparison with Stack (1), the embodiment of Stack (2) has lower security factor in the direction of peak security factor, S₁₀₀ which according to eqn. 10, is irrespective of the value of a. It would be expected that introducing the guest material 414B and reflective polariser 302 in the same stack would undesirably provide reduced security factor performance of the display device 100, arising from the double pass of reflected light at an oblique angle through the layer of the guest-host liquid crystal retarder 301, electrodes 317 and additional polariser 318, and this reduction is indeed seen in the direction of peak security factor S₁₀₀.

A display without the guest material 414B may be provided with a light copper metallic aesthetic appearance and a display with the guest material 414B may have a dark bronze metallic appearance. By comparison, Stack (3) provides a dark appearance which does not provide any indication of privacy function of the display, rather the display appears to be off. The aesthetic appearance of Stack (1) and the embodiment of Stack (2) provides enhanced aesthetic appearance and knowledge to the snooper 47 that the display is operating in privacy mode rather than off. It has been found that such functionality gives improved confidence to the display user that the display is operating in privacy mode.

Further, the metallic appearance of the reflected light rays 406 arising from the specular nature of the reflection advantageously achieves increased visibility of background structures that are illuminating the display as light sources 604. Such structure may achieve increased camouflage effect, advantageously reducing the visibility of image data.

Returning to the description of FIG. 3C, the size of the polar region over which the polar control retarder 300 and additional polariser 318 with no guest material 414B has transmission below 20% is illustrated by polar region 490; and in FIG. 3D the size of the polar region over which the polar control retarder 300 and additional polariser 318 with 1% guest material 414B has transmission below 20% is illustrated by polar region 492. The size of the polar region 492 is increased in comparison to the size of the polar region 490 and particularly is increased at higher lateral angles.

Comparing Stack (3) with the embodiment of Stack (2), it has further been appreciated that the reflective polariser 302 increases security factor of displays with guest material 414B incorporated. Thus the present embodiments achieve improved size of polar region for which acceptable security factor is achieved.

FIG. 15C describes a method for the measurement of display device 100 reflectance.

In a first measurement step M1 the arrangement of FIG. 5B is provided wherein a reference glass slide 485 of known refractive index is arranged to receive light from a light source 604 at the direction of viewing ϕ′ and reflected towards detector 483 that may for example be a photopic photodetector.

In a second step M2 the brightness of a reference light source 604 is calculated. The Fresnel reflectance of said reference glass slide 485 may be calculated using known Fresnel reflectance equations. The reflected power of the light source 604 for 100% surface reflectivity is calculated.

In a third step M3A the reference glass slide 485 is replaced by the display device 100. In the case that the front surface of the display device 100, such as protective layer 328A, has a diffusing structure then an index matching layer with a planar front surface, such as a further glass slide attached to the front surface of the display device 100 by means of an index matching material may be provided to eliminate the diffusion effect.

In a fourth step M4A the display device 100 reflected power is measured by the detector 483 in a state of operation of the guest-host liquid crystal retarder 301 in which the voltage V is adjusted to minimise the reflectivity of the display device 100. The reflectance ρₘᵢₙ₁₀₀ in the said state is measured as the ratio of the reflected power to the power of the light source 604 in said minimum reflectance state and is approximately the reflectance of light rays 480A-E.

In a fifth step M5A the display device 100 reflected power is measured by the detector 483 in a state of operation of the guest-host liquid crystal retarder 301 in which the voltage V is adjusted to maximise the reflectivity of the display device 100. The reflectance ρ_{max 100} in the said state is measured as the ratio of the reflected power to the power of the light source 604 in said maximum reflectance state is the reflectance of light rays 482.

In a sixth step M6A the display reflectance δρd100 excluding any surface reflections besides reflection from the reflective polariser 302 is calculated as:

$${δρ}_{302} = {ρ}_{max 100} - {ρ}_{min 100} \qquad eqn . 13$$

In each direction ϕ inclined to a normal 199 to the display device 100, the difference between the maximum reflectance ρₘₐₓ of the display device 100 and the minimum reflectance ρₘᵢₙ of the display device 100 across all switchable states of the host material 414A, i.e. for all drive voltages V, of the host material 414A is at most 15%. Advantageously the display device 100 may provide increased size of the polar region for which acceptable security factor S. The guest material 414B may be provided with low cost, and the size of the polar region for desirable security factor, S may be increased.

FIG. 15D describes an alternative method for the measurement of display device 100 reflectance.

By way of comparison with FIG. 15C, in the alternative embodiment of FIG. 15D, the component 260 reflectance is measured when the reflective polariser 302 is removed and compared with the reflectance of the component 260 with the reflective polariser 302 still in place. The removal of the reflective polariser 302 may be provided by for example delamination of the reflective polariser 302 from the passive compensation retarder 330 and replacing it with a laminated glass substrate (not shown) with substantially the same refractive index as the reflective polariser 302. A light absorbing material may be provided in the gap 338.

In a third step M3B the reference glass slide 485 is replaced by the component 260. In the case that the front surface of the component, such as protective layer 328A, has a diffusing structure then an index matching layer with a planar front surface, such as a further glass slide attached to the front surface of the display device 100 by means of an index matching material may be provided to eliminate the diffusion effect.

In a fourth step M4B the component 260 comprises the reflective polariser 302 and the reflected power is measured by the detector 483 in a state of operation of the guest-host liquid crystal retarder 301 in which the voltage V is adjusted to maximise the reflectivity of the display device 100. The reflectance ρₘₐₓ₂₆₀ in the said state is measured as the ratio of the reflected power to the power of the light source 604 in said minimum reflectance state and is approximately the reflectance of light rays 480A-D.

In a fifth step M4B the component 260 does not comprise the reflective polariser 302 and the reflected power is measured by the detector 483 in a state of operation of the guest-host liquid crystal retarder 301 in which the voltage V is adjusted to maximise the reflectivity of the display device 100. The reflectance ρ_{NO_302} in the said state is measured as the ratio of the reflected power to the power of the light source 604 in said minimum reflectance state and is approximately the reflectance of light rays 480A-C and the reflectance 480D from the lower surface of the laminated glass substrate.

In a sixth step M6B the display reflectance δρ₂₆₀ excluding any surface reflections besides reflection from the reflective polariser 302 is calculated as:

$${δρ}_{260} = {ρ}_{max 260} - {ρ}_{NO \_ 302} \qquad eqn . 14$$

In each switchable state of the host material 414A, considering a combination of: (i) the additional polariser 318; (ii) the guest-host liquid crystal retarder 301 and (iii) any other retarder such as passive compensation retarder 330 arranged between the additional polariser 318 and the reflective polariser 302; and the reflective polariser 302, the contribution ρ₃₀₁ to the reflectance of the display device 100 provided by that combination and excluding any surface reflections 480 besides reflection of light 406 from the reflective polariser 302 is at most 15% in all directions inclined to a normal 199 to the display device 100.

Advantageously the display device 100 may provide increased size of the polar region for which acceptable security factor S. The guest material 414B may be provided with low cost, and the size of the polar region for desirable security factor, S may be increased.

Coloured reflection of light rays 406 when reflected from the display device 100 when operating in privacy mode will now be described.

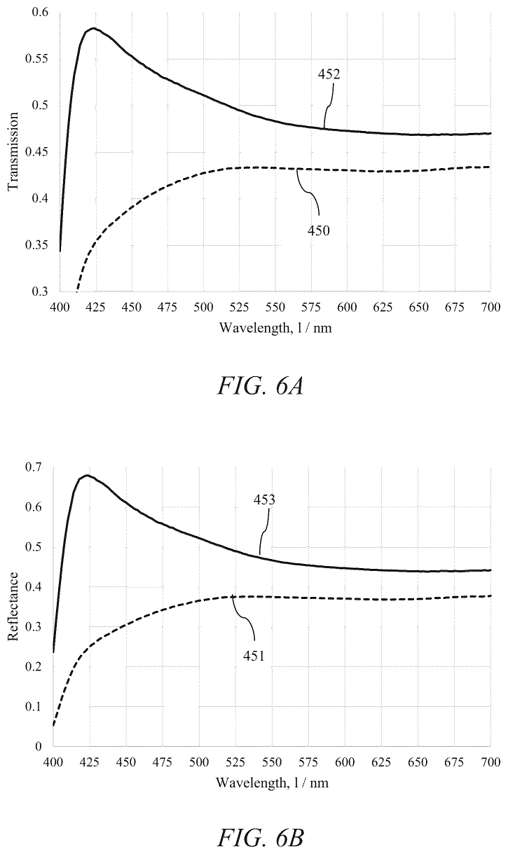

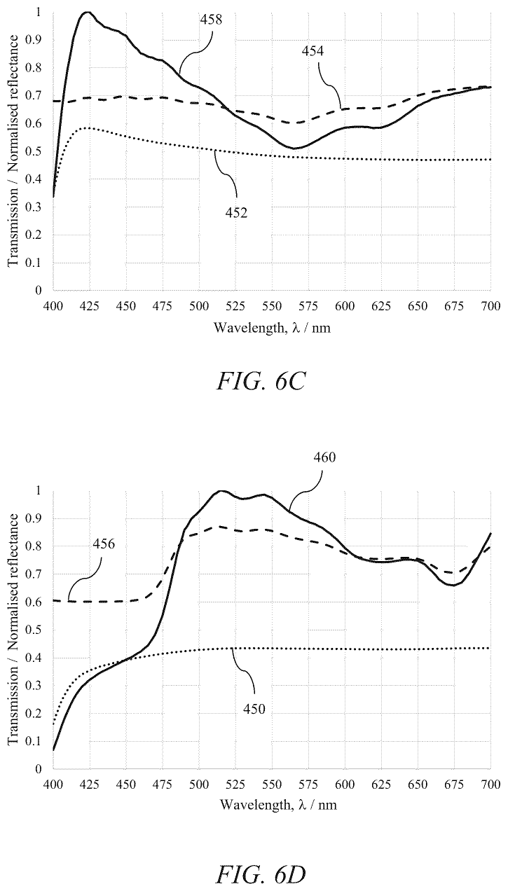

FIG. 6A is a schematic graph illustrating the spectral variation profile 450 of transmission for a conventional dichroic additional polariser 318 and the spectral profile 452 of a high blue transmission dichroic additional polariser 318; and FIG. 6B is a schematic graph illustrating the spectral profile 451 of reflectance ρ₃₀₁ for a display device 100 comprising the conventional dichroic additional polariser 318 and an alternative display device 100 comprising the high blue transmission dichroic additional polariser 318 has a spectral profile 453 wherein the guest-host dye material 414B has uniform transmission with wavelength, λ. Features of the embodiments of FIGS. 6A-B not discussed in further detail may be assumed to correspond to the features with equivalent reference numerals as discussed above, including any potential variations in the features.

Conventional dichroic polarisers as illustrated by profile 450 may be provided at lower cost than high blue transmission polarisers and may provide higher contrast when used as display polarisers 210, 218 for example. By comparison in the present embodiments, the additional polariser 318 has a more relaxed contrast performance in order to achieve desirable security performance.

In operation the profile 451 may provide a copper coloured metallic reflection, while the profile 453 may provide a more silvered or blueish coloured reflection. The polariser spectral variation profile may be selected to advantageously change the reflected colour of the display device 100. Such colour selection may be used to demonstrate different levels of performance between different brands or product line-ups. The security factor may be higher for the profile 453 compared to the profile 451 as well as having a different colour.

It may be desirable to provide yet further embodiments of different coloured reflections.

FIG. 6C is a schematic graph illustrating the spectral variation of (i) the transmission profile 452 of a high blue transmission dichroic additional polariser 318, (ii) the illustrative transmission profile 454 of a lilac dye material 414B of a guest-host liquid crystal retarder 301 for use with the high blue transmission dichroic polariser 318 profile 452 and (iii) the normalised reflectance profile 458 for a display device 100 comprising the high blue transmission dichroic polariser profile 452 and the lilac dye material 414B profile 454; and FIG. 6D is a schematic graph illustrating the spectral variation of (i) the transmission profile 450 of a conventional dichroic additional polariser 318, (ii) the illustrative transmission profile 456 of a green dye material 414B of a guest-host liquid crystal retarder 301 for use with the conventional dichroic polariser 318 profile 450 and (iii) the normalised reflectance profile 460 for a display device 100 comprising the conventional dichroic polariser 318 profile 450 and the green dye material 414B profile 456. Features of the embodiments of FIGS. 6C-D not discussed in further detail may be assumed to correspond to the features with equivalent reference numerals as discussed above, including any potential variations in the features.

By way of comparison with FIG. 6B, in the alternative embodiments of FIGS. 6C-D, the guest material 414B has a transmission in the visible spectrum that varies with wavelength, λ.

In the alternative embodiment of FIG. 6C, the additional polariser 318 has a transmission profile 452 in the visible spectrum with a transmission that is greater at all wavelengths below 475 nm than at 475 nm. Further, profile 454 indicates that the transmission in the visible spectrum of the guest material 414B is greater at all wavelengths below 500 nm than at any wavelength in the range from 500 nm to 550 nm.

In operation, the embodiment of FIG. 6C achieves a reflectance profile 458 that has increased reflectance in the blue and red ranges, and with high efficiency. Advantageously a blue or magenta coloured reflection may be achieved with high efficiency

By comparison with FIG. 6C, in the alternative embodiment of FIG. 6D, the additional polariser 318 has a transmission profile 450 in the visible spectrum that monotonically increases with increasing wavelengths up to 475 nm and has transmission that is greater at all visible wavelengths above 475 nm than at a wavelength of 475 nm. Further the transmission in the visible spectrum of the guest material 414B has a maximum value at a wavelength of at least 475 nm, preferably at least 500 nm. Advantageously a green coloured reflection may be achieved with high efficiency.

The alternative embodiments of FIGS. 6C-D illustrate that aesthetically desirable reflectance colour can be achieved in a manner that optimises the security factor by providing increased photopic reflectance ρ₃₀₁ across the visible spectrum in desirable wavelength bands. Such colour selection may be used to demonstrate different levels of performance between different brands or product line-ups. The security factor may be higher for the profile 453 compared to the profile 451 as well as having a different colour.

The dye guest material 414B may introduce some change in the output colour of the pixels 222R, 222G, 222B of the spatial light modulator 48. Such colour variation may be corrected by control system 502 as illustrated in FIG. 1 correcting the colour mapping of the input image to the spatial light modulator 48, or by adjusting the colour output of the light from the pixels 222R, 222G, 222B.

The operation of the privacy mode of the display of FIG. 1A will now be described further.

FIG. 7A is a schematic diagram illustrating in front perspective view observation of transmitted output light for a display operating in privacy mode. Features of the embodiment of FIG. 7A not discussed in further detail may be assumed to correspond to the features with equivalent reference numerals as discussed above, including any potential variations in the features.

Display device 100 may be provided with white regions 603 and black regions 601. A snooper may observe an image on the display if luminance difference between the observed regions 601, 603 can be perceived. In operation, primary user 45 observes a full luminance images by rays 400 to viewing locations 26 that may be optical windows of a directional display. Snooper 47 observes reduced luminance rays 402 in viewing locations 27 that may be optical windows of a directional display. Regions 26, 27 further represent on-axis and off-axis regions of FIG. 3C.

FIG. 7B is a schematic diagram illustrating in front perspective views the appearance of the display of FIG. 1A operating in privacy mode 1 with luminance variations as illustrated in FIG. 3C. Features of the embodiment of FIG. 7B not discussed in further detail may be assumed to correspond to the features with equivalent reference numerals as discussed above, including any potential variations in the features.

Thus upper viewing quadrants 530, 532, lower viewing quadrants 534, 536 and lateral viewing positions 526, 528 provide reduced luminance, whereas up/down central viewing regions 522, 520 and head-on viewing provides much higher luminance.

In retail environments it is now common to be presented with a Point Of Sale (POS) terminal comprising a display screen to make or manage purchases. In some cases, the screen is operated by a staff member and in some cases by the customer themselves. These screens may vary in size from about 2-inch diagonal up to 20-inch diagonal or more. As the display screens get larger it becomes more difficult to shield the operation of the display from onlookers (snoopers) with the body or hands. Screen privacy is desirable in the case of inputting a PIN number or desired when reviewing previous purchases or loyalty card personal data and/or personalized promotions.

Some POS terminals are fitted with a separate keypad which has a physical frame feature deployed around it to aid in the shielding of the PIN input process. However, when using larger screen devices or where the keypad is “soft” i.e., displayed on a portion of the screen that has a touch function, mechanical shielding is not helpful because it would detract of the regular use of the display screen to relay images or text to the customer. In this case it would be desirable to have a display screen that could switch to a restricted angular output (a privacy mode) when sensitive information was either displayed or being input. Further, when for example being assisted by staff to complete a purchase, or when the POS display is not serving a customer, a wider-angle screen mode is desirable. In the wide mode the POS device can attract and hold the attention of passing potential customers to for example promote special offers or welcome them to the POS payment device.

It may be desirable to provide controllable display illumination in an automotive vehicle.

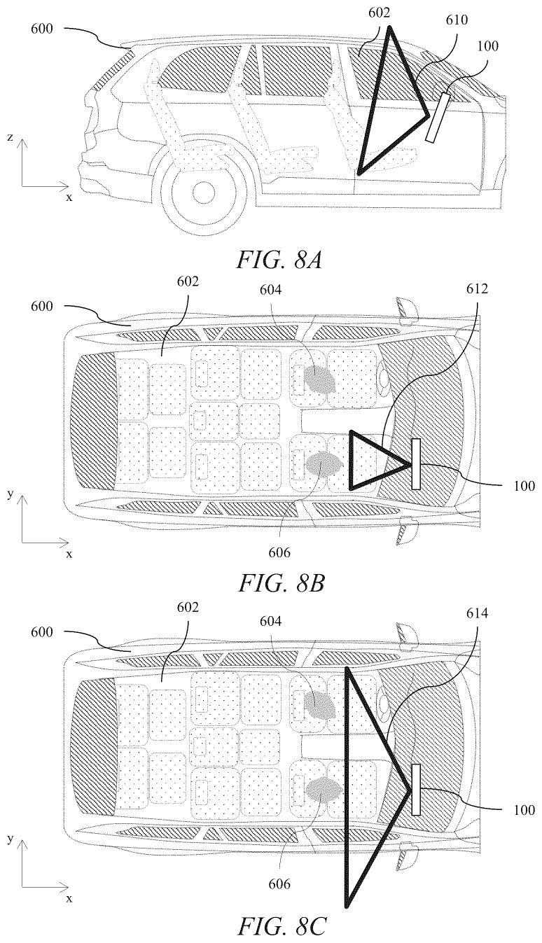

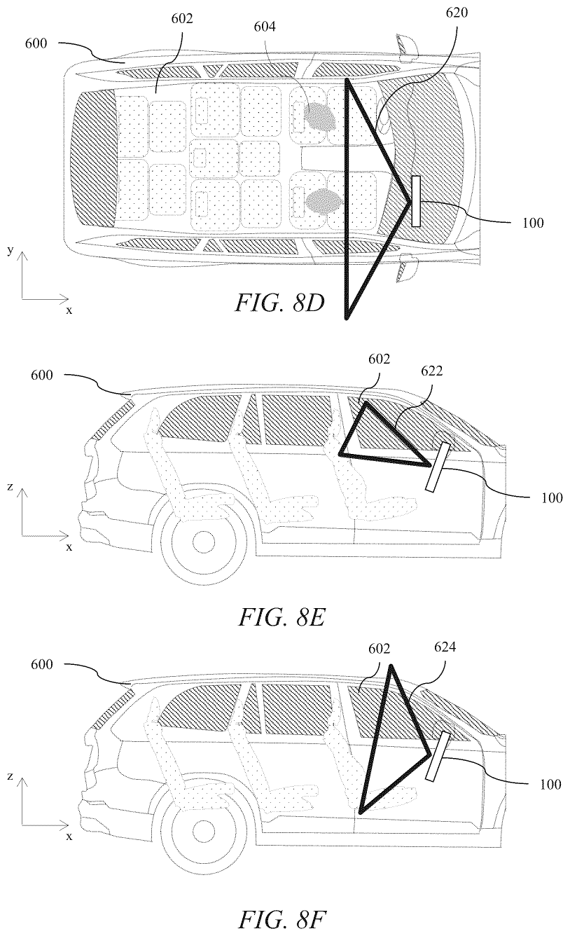

FIG. 8A is a schematic diagram illustrating in side view an automotive vehicle with a switchable display device 100 arranged within the vehicle cabin 602 of an automotive vehicle 600 for both entertainment and sharing modes of operation. Features of the embodiment of FIG. 8A not discussed in further detail may be assumed to correspond to the features with equivalent reference numerals as discussed above, including any potential variations in the features.

Light cone 610 (for example representing the cone of light within which the luminance is greater than 50% of the peak luminance) may be provided by the luminance distribution of the display device 100 in the elevation direction and is not switchable.

FIG. 8B is a schematic diagram illustrating in top view an automotive vehicle with a switchable display device 100 arranged within the vehicle cabin 602 in an entertainment mode of operation and operates in a similar manner to a privacy display. Features of the embodiment of FIG. 8B not discussed in further detail may be assumed to correspond to the features with equivalent reference numerals as discussed above, including any potential variations in the features.

Light cone 612 is provided with a narrow angular range such that passenger 606 may see the display device 100 whereas driver 604 may not see an image on the display device 100. Advantageously entertainment images may be displayed to the passenger 606 without distraction to the driver 604.

FIG. 8C is a schematic diagram illustrating in top view an automotive vehicle with a switchable display device 100 arranged within the vehicle cabin 602 in a sharing mode of operation. Features of the embodiment of FIG. 8C not discussed in further detail may be assumed to correspond to the features with equivalent reference numerals as discussed above, including any potential variations in the features.

Light cone 614 is provided with a wide angular range such that all occupants may perceive an image on the display device 100, for example when the display is not in motion or when non-distracting images are provided.

FIG. 8D is a schematic diagram illustrating in top view an automotive vehicle with a switchable display device 100 arranged within the vehicle cabin 602 for both night-time and day-time modes of operation. Features of the embodiment of FIG. 8D not discussed in further detail may be assumed to correspond to the features with equivalent reference numerals as discussed above, including any potential variations in the features.

In comparison to the arrangements of FIGS. 8A-C, the optical output is rotated so that the display elevation direction is along an axis between the driver 604 and passenger 606 locations. Light cone 620 illuminates both driver 604 and passenger 606.

FIG. 8E is a schematic diagram illustrating in side view an automotive vehicle with a switchable display device 100 arranged within the vehicle cabin 602 in a night-time mode of operation. Features of the embodiment of FIG. 8E not discussed in further detail may be assumed to correspond to the features with equivalent reference numerals as discussed above, including any potential variations in the features.

Thus the display may provide a narrow angular output light cone 622. Stray light that illuminates internal surfaces and occupants of the vehicle cabin 602 and cause distraction to driver 604 may advantageously be substantially reduced. Both driver 604 and passenger 606 may advantageously be able to observe the displayed images.

FIG. 8F is a schematic diagram illustrating in side view an automotive vehicle with a switchable display device 100 arranged within the vehicle cabin 602 in a day-time mode of operation. Features of the embodiment of FIG. 8F not discussed in further detail may be assumed to correspond to the features with equivalent reference numerals as discussed above, including any potential variations in the features.

Thus the display may provide a narrow angular output light cone 624. Advantageously the display may be conveniently observed by all cabin 602 occupants.

The displays 100 of FIGS. 8A-F may be arranged at other vehicle cabin locations such as driver instrument displays, centre console displays and seat-back displays.

Returning to the discussion of the present embodiments, further arrangements of compensated switchable retarders 300 will now be described.

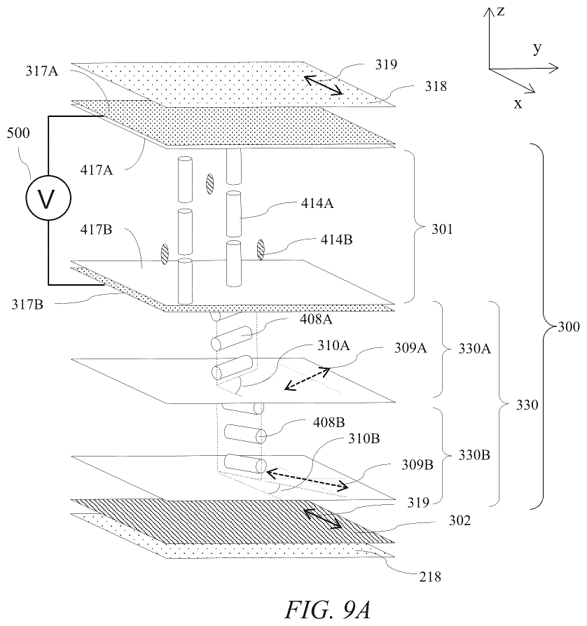

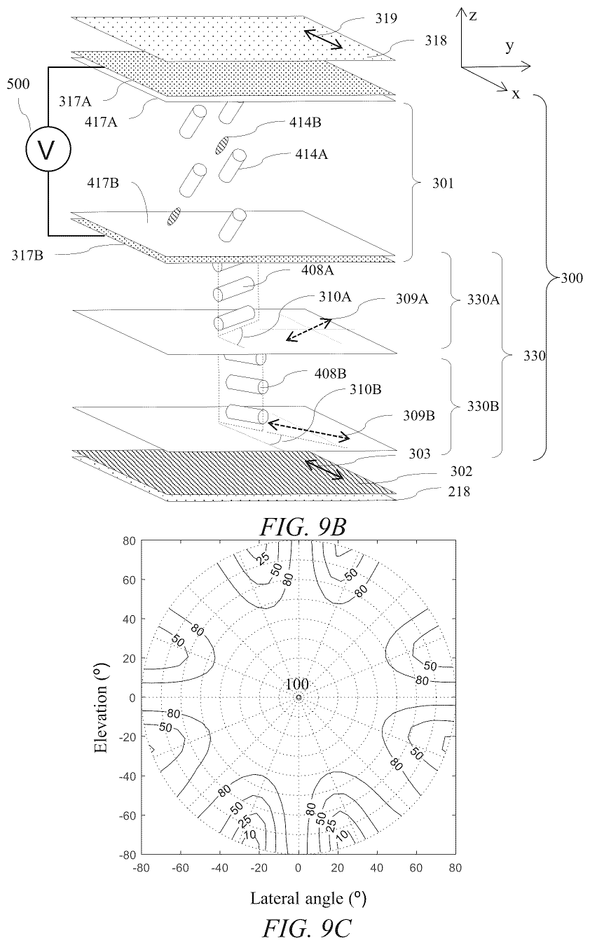

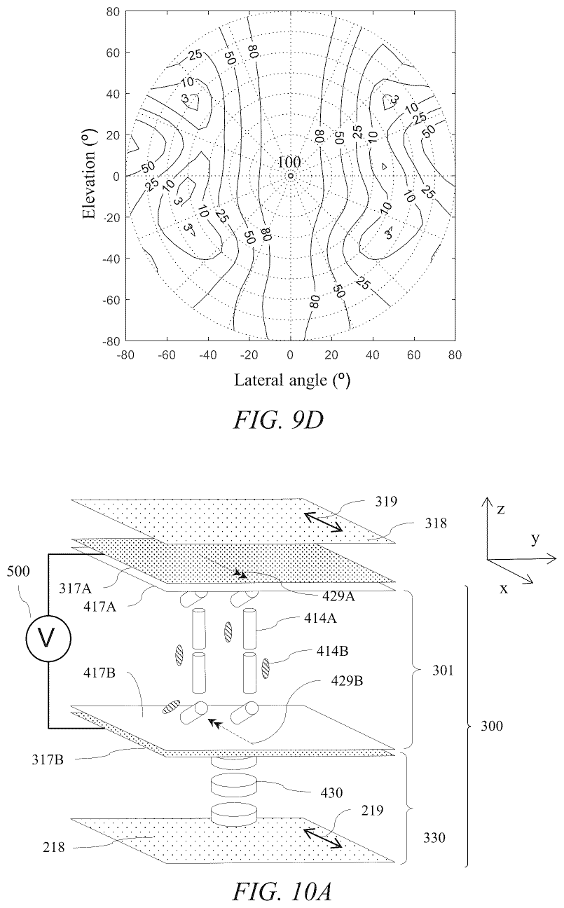

FIG. 9A is a schematic diagram illustrating in perspective side view an arrangement of a switchable retarder in a privacy mode of operation comprising crossed A-plate passive compensation retarders 330A, 330B and homeotropically aligned switchable guest-host liquid crystal retarder 301; and FIG. 9B is a schematic diagram illustrating in perspective side view an arrangement of a switchable compensated retarder in a privacy mode of operation comprising crossed A-plate passive compensation retarders and homeotropically aligned switchable liquid crystal retarder. Features of the embodiments of FIGS. 9A-B not discussed in further detail may be assumed to correspond to the features with equivalent reference numerals as discussed above, including any potential variations in the features.

In comparison to the embodiment of FIG. 3A, the compensation retarder 330 may alternatively comprise a pair of retarders 330A, 330B which have optical axes in the plane of the retarders that are crossed. The compensation retarder 330 thus comprises a pair of retarders 330A, 330B that each comprise a single A-plate.

The pair of retarders 330A, 330B each comprise plural A-plates having respective optical axes 309A, 309B aligned at different angles with respect to each other. The pair of retarders have optical axes 309A, 309B that each extend at 45° with respect to an electric vector transmission direction that is parallel to the electric vector transmission direction 211 of the input display polariser 210 in the case that the additional polariser 318 is arranged on the input side of the input display polariser or is parallel to the electric vector transmission direction 219 of the output display polariser 218 in the case that the additional polariser 318 is arranged on the output side of the input display polariser 218.

FIG. 9C is a schematic graph illustrating the variation of output transmission with polar direction for transmitted light rays in FIG. 9A in a wide-angle mode of operation; and FIG. 9D is a schematic graph illustrating the variation of output transmission with polar direction for transmitted light rays in FIG. 9B in a privacy mode of operation provided by the illustrative embodiment of TABLE 4. Features of the embodiments of FIGS. 9C-D not discussed in further detail may be assumed to correspond to the features with equivalent reference numerals as discussed above, including any potential variations in the features.

TABLE 4

| | | Passive compensation retarder(s) | | Active LC retarder | | | | |
|---|---|---|---|---|---|---|---|---|
| | | | Δn.d/ | Alignment | Pretilt/ | Δn.d/ | | Voltage/ |
| FIG. | Mode | Type | nm | layers | deg | nm | Δε | V |
| 9A | Wide | Crossed A | +650 @ 45° | Homeotropic | 88 | 810 | −4.3 | 0 |
| 9D | Privacy | | +650@ 135° | Homeotropic | 88 | | | 2.3 |

When the passive compensation retarder 330 comprises a pair of retarders which have optical axes in the plane of the retarders that are crossed, each retarder of the pair of retarders has a retardance for light of a wavelength of 550 nm between 300 nm and 800 nm, preferably between 500 nm and 700 nm and most preferably between 550 nm and 675 nm.

Advantageously A-plates may be more conveniently manufactured at lower cost than for the C-plate retarder of FIG. 3F and FIG. 3A. Further a zero voltage state may be provided for the wide-angle mode of operation, minimising power consumption during wide-angle operation.

In the present embodiments, ‘crossed’ refers to an angle of substantially 90° between the optical axes of the two retarders in the plane of the retarders. To reduce cost of retarder materials, it is desirable to provide materials with some variation of retarder orientation due to stretching errors during film manufacture for example. Variations in retarder orientation away from preferable directions can reduce the head-on luminance and increase the minimum transmission. Preferably the angle 310A is at least 35° and at most 55°, more preferably at least 40° and at most 50° and most preferably at least 42.5° and at most 47.5°. Preferably the angle 310B is at least 125° and at most 145°, more preferably at least 130° and at most 135° and most preferably at least 132.5° and at most 137.5°.

During mechanical distortion, such as when touching the display, the homeotropically aligned liquid crystal retarders 301 of FIGS. 9C-D may have undesirably long recovery times creating visible misalignment artefacts. It would be desirable to provide fast recovery times after mechanical distortion.

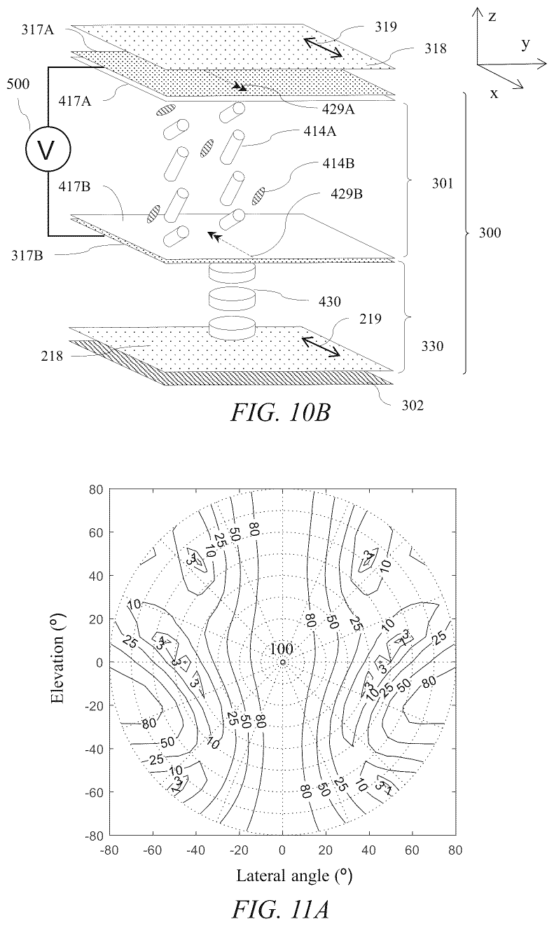

FIGS. 10A-B are schematic diagrams illustrating in perspective side view an arrangement of a switchable retarder in a wide-angle and privacy mode of operation respectively comprising a homogeneously aligned switchable liquid crystal retarder comprising liquid crystal material 414 with a positive dielectric anisotropy and a passive negative C-plate retarder 330 for first and second drive voltages respectively. Features of the embodiments of FIG. 10A-B not discussed in further detail may be assumed to correspond to the features with equivalent reference numerals as discussed above, including any potential variations in the features.

The switchable liquid crystal retarder further comprises surface alignment layers 417A, 417B disposed adjacent to the layer of liquid crystal material 414 and each arranged to provide homogeneous alignment in the adjacent liquid crystal material. In other words, the switchable liquid crystal retarder comprises two surface alignment layers 417A, 417B disposed adjacent to the layer of liquid crystal material 414 and on opposite sides thereof and each arranged to provide homogeneous alignment in the adjacent liquid crystal material 414.

Resolved component of liquid crystal tilt compared to the direction perpendicular to the plane of the retarder is substantially higher than components 429A, 429B of FIG. 3A.

The increased magnitude of resolved component 429A, 429B may provide increased restoring force after mechanical distortion in comparison to the arrangement of FIG. 9A for example. Sensitivity to mechanical distortions such as during touching the display may advantageously be reduced.

The voltage of operation may be reduced below 10V for acceptable wide-angle field of view, reducing power consumption; and reducing cost and complexity of electrical driving.

FIG. 10A and other illustrative diagrams herein illustrate that the alignment directions 429A, 429B are anti-parallel and further are aligned parallel to the electric vector transmission directions 303, 319 of the polarisers 302, 318 respectively. In other embodiments (not shown) the alignment directions 429A, 429B may have components in the plane of the retarder 301 that are inclined to the electric vector transmission directions 303, 319. The direction of the peak luminance and the direction of the minimum absorption when operating in privacy mode may be adjusted. Advantageously display devices 100 that are arranged to operate for off-axis viewing directions such as for passenger infotainment displays in automotive vehicles may achieve improved directional light control characteristics. The inclination of alignment directions is described further in U.S. Pat. No. 11,079,646 (Atty. Ref. No. 419001) and U.S. Pat. No. 11,099,448 (Atty. Ref. No. 472001), both of which are herein incorporated by reference in their entireties.

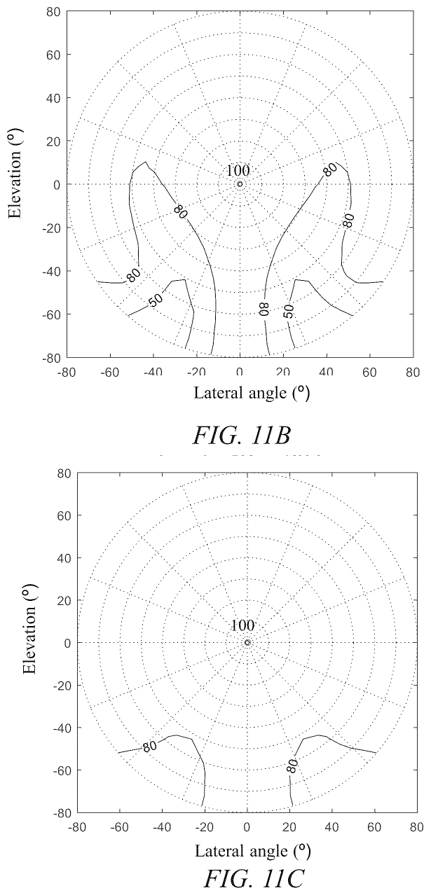

FIGS. 11A-11C are schematic graphs illustrating the variation of output transmission with polar direction for transmitted light rays of switchable compensated retarder comprising a homogeneously aligned guest-host liquid crystal retarder 301 and a passive negative C-plate compensation retarder 330, similar to the display device of FIGS. 10A and 10B, in a privacy mode and two different wide-angle modes for different drive voltages comprising the embodiments illustrated in TABLE 5. Features of the embodiments of FIGS. 11A-C not discussed in further detail may be assumed to correspond to the features with equivalent reference numerals as discussed above, including any potential variations in the features.

TABLE 5

| | | Passive compensation retarder(s) | | Active LC retarder | | | | |
|---|---|---|---|---|---|---|---|---|
| | | | Δn.d/ | Alignment | Pretilt/ | Δn.d/ | | Voltage/ |
| FIG. | Mode | Type | nm | layers | deg | nm | Δε | V |
| 11A | Privacy | Negative C | −500 | Homogeneous | 2 | 750 | +13.2 | 2.3 |
| 11B | Wide | | | Homogeneous | 2 | | | 5.0 |
| 11C | Wide | | | | | | | 10.0 |

Desirable ranges for optical retardance for active LC retarder 301 comprising homogeneous alignment layers 417A, 417B on both substrates and a passive negative C-plate compensation retarder 330 are further described in TABLE 6.

TABLE 6

| | Minimum | Typical | Maximum |
|---|---|---|---|
| | negative | negative | negative |
| Active LC layer | C-plate | C-plate | C-plate |
| retardance / nm | retardance / nm | retardance / nm | retardance / nm |
| 600 | −300 | −400 | −500 |
| 750 | −500 | −450 | −600 |
| 900 | −400 | −500 | −700 |

The switchable liquid crystal retarder 300 thus comprises a first surface alignment layer 417A disposed on a first side of the layer of liquid crystal material 414, and a second surface alignment layer 417B disposed on the second side of the layer of liquid crystal material 414 opposite the first side; wherein the first surface alignment layer 417A is a homogeneous alignment layer and the second surface alignment layer is a homogeneous alignment layer; wherein the layer of liquid crystal material has a retardance for light of a wavelength of 550 nm in a range from 500 nm to 1000 nm, preferably in a range from 600 nm to 850 nm and most preferably in a range from 700 nm to 800 nm. Thus when the first and second alignment layers are each homogeneous alignment layers and when the passive compensation retarder 330 comprises a retarder having an optical axis perpendicular to the plane of the retarder, the passive retarder has a retardance for light of a wavelength of 550 nm in a range from −300 nm to −700 nm, preferably in a range from −500 nm to −600 nm and most preferably in a range from −400 nm to −500 nm.

Advantageously off-axis privacy can be provided by means of luminance reduction, reflection increase and security level increase over wide polar regions. Further resistance to visual artefacts arising from flow of liquid crystal material in the layer 314 may be improved in comparison to homeotropic alignment.

Various other configurations of the optical structure and driving of FIG. 10A will now be described.

Operation at 5V provides lower power consumption and lower-cost electronics while achieving acceptable luminance roll-off in wide-angle mode. Field of view in wide-angle mode can further be extended by operation 10V.

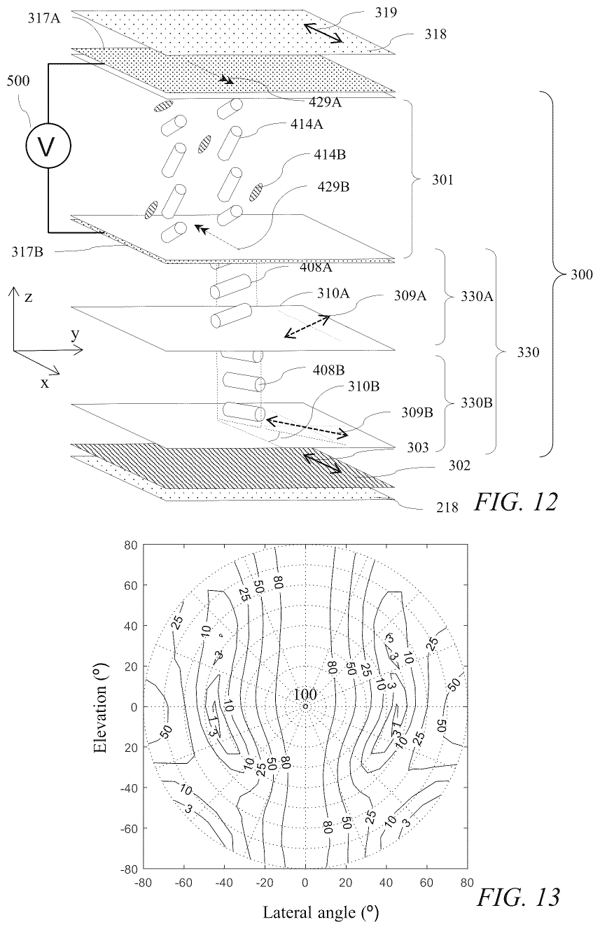

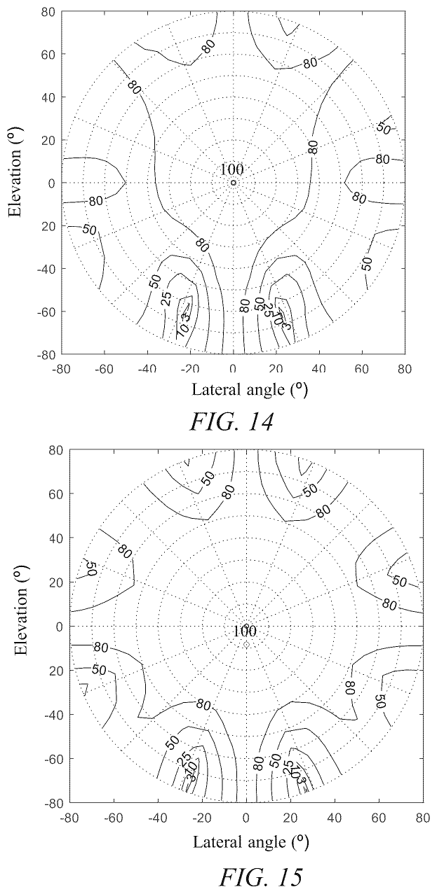

FIG. 12 is a schematic diagram illustrating in perspective side view an arrangement of a switchable compensated retarder in a privacy mode of operation, the arrangement comprising crossed A-plate passive compensation retarders 330A, 330B and homogeneously aligned switchable guest-host liquid crystal retarder 301; and FIGS. 13-15 are schematic graphs illustrating the variation of output transmission with polar direction for transmitted light rays of switchable compensated retarder 301 comprising a homogeneously aligned liquid crystal material 414 and passive crossed A-plate retarders 330A, 330B, in a privacy mode and a wide-angle mode for different drive voltages comprising the respective embodiments illustrated in TABLE 7. Features of the embodiments of FIGS. 12-15 not discussed in further detail may be assumed to correspond to the features with equivalent reference numerals as discussed above, including any potential variations in the features.

TABLE 7

| | | Passive compensation retarder(s) | | Active LC retarder | | | | |
|---|---|---|---|---|---|---|---|---|
| | | | Δn.d/ | Alignment | Pretilt/ | Δn.d/ | | Voltage/ |
| FIG. | Mode | Type | nm | layers | deg | nm | Δε | V |
| 13 | Privacy | Crossed A | +500 @ 45° | Homogeneous | 2 | 750 | +13.2 | 2.3 |
| 14 | Wide | | +500 @ 135° | Homogeneous | 2 | | | 5 |
| 15 | Wide | | | | | | | 10 |

Desirable ranges for optical retardance for active LC retarder 301 comprising homogeneous alignment layers 417A, 417B on both substrates and crossed positive A-plate retarders 330A, 330B are further described in TABLE 8.

TABLE 8

| | Minimum | Typical | Maximum |
|---|---|---|---|
| | positive | positive | positive |
| Active LC layer | A-plate | A-plate | A-plate |
| retardance / nm | retardance / nm | retardance / nm | retardance / nm |
| 600 | +300 | +400 | +600 |
| 750 | +500 | +500 | +700 |
| 900 | +400 | +600 | +800 |

Thus when the first and second alignment layers are each homogeneous alignment layers; the layer of liquid crystal material has a retardance for light of a wavelength of 550 nm in a range from 500 nm to 1000 nm, preferably in a range from 600 nm to 850 nm and most preferably in a range from 700 nm to 800 nm; and the passive compensation retarder 330 comprises a pair of retarders which have optical axes in the plane of the retarders that are crossed, then each retarder of the pair of retarders has a retardance for light of a wavelength of 550 nm between 300 nm and 800 nm, preferably between 500 nm and 650 nm and most preferably between 450 nm and 550 nm.

Further crossed A-plates may be conveniently provided from low cost materials.

By way of illustration various other example embodiments of the optical structure and driving of FIG. 12 will now be described. FIG. 14 and FIG. 15 further illustrate that by adjustment of addressing voltage and retardances, advantageously different wide-angle fields of view may be achieved.

It may be desirable to provide the additional polariser with a different electric vector transmission direction to the electric vector transmission direction of the display polariser.

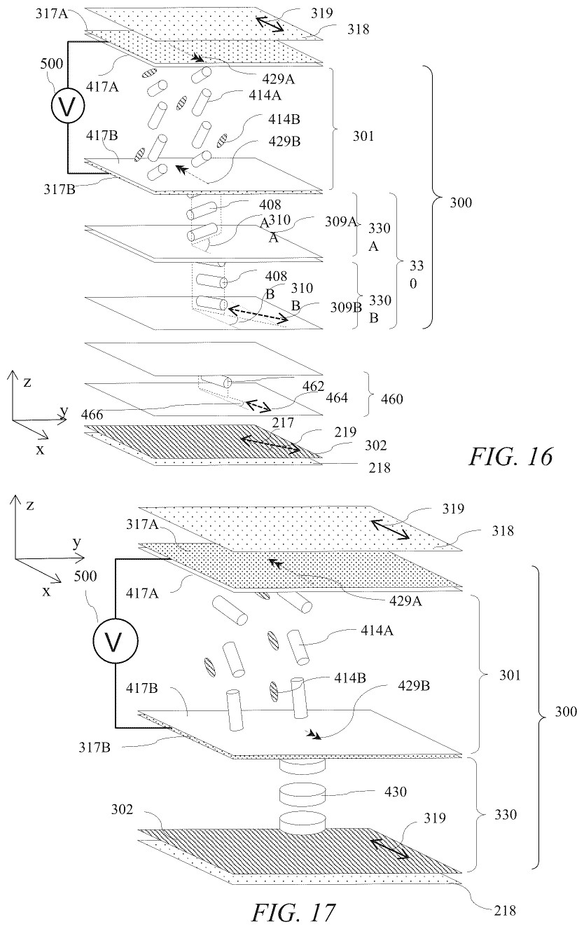

FIG. 16 is a schematic diagram illustrating in perspective side view an arrangement of a switchable compensated retarder in a privacy mode of operation comprising the crossed A-plate passive compensation retarders 330A, 330B and homogeneously aligned switchable guest-host liquid crystal retarder 301, as described above but further comprising a passive rotation retarder 460. Features of the embodiment of FIG. 16 not discussed in further detail may be assumed to correspond to the features with equivalent reference numerals as discussed above, including any potential variations in the features.

The display polariser 218 may be provided with an electric vector transmission direction 219, that may be for example at an angle 317 of 45 degrees in the case of a twisted nematic LCD display. The additional polariser 318 may be arranged to provide vertically polarised light to a user who may be wearing polarising sunglasses that typically transmit vertically polarised light.

The passive rotation retarder 460 is different to the compensation retarder 330 of the present embodiments and its operation will now be described.

Passive rotation retarder 460 may comprise a birefringent material 462 and be a half waveplate, with retardance at a wavelength of 550 nm of 275 nm for example.

Passive rotation retarder 460 has a fast axis orientation 464 that is inclined at an angle 466 that may be 22.5 degrees to the electric vector transmission direction 319 of the additional polariser 318. The passive rotation retarder 460 thus rotates the polarisation from the output polariser 218 such that the polarisation direction of the light that is incident onto the compensation retarder 330B is parallel to the direction 319.

The passive rotation retarder 460 modifies the on-axis polarisation state, by providing an angular rotation of the polarisation component from the display polariser 218. In comparison, the compensation retarders 330A, 330B together do not modify the on-axis polarisation state.

Further, the passive rotation retarder 460 provides a rotation of polarisation that may be substantially independent of viewing angle. In comparison, the compensation retarders 330A, 330B provide substantial modifications of output luminance with viewing angle.

Advantageously a display may be provided with an output polarisation direction 319 that is different from the display polariser polarisation direction 219, for example to provide viewing with polarising sunglasses.

In an alternative embodiment the separate retarder 460 may be omitted and the retardance of the retarder 330B of FIG. 11A increased to provide an additional half wave rotation in comparison to the retardance of retarder 330A. To continue the illustrative embodiment, the retardance of retarder 330B at a wavelength of 550 nm may be 275 nm greater than the retardance of retarder 330A. Advantageously the number of layers, complexity and cost may be reduced.

In alternative embodiments (not illustrated) the passive rotation retarder 460 may be provided between the reflective polariser 302 and the display polariser 218. Advantageously the viewing angle properties of the security factor may be improved.

Hybrid aligned structures comprising both homogeneous and homeotropic alignment layers will now be described.

FIG. 17 is a schematic diagram illustrating in perspective side view an arrangement of a switchable retarder in a privacy mode of operation comprising a homogeneously and homeotropically aligned switchable guest-host liquid crystal retarder 301 comprising liquid crystal material 423 and a passive negative C-plate retarder 330. Features of the embodiment of FIG. 17 not discussed in further detail may be assumed to correspond to the features with equivalent reference numerals as discussed above, including any potential variations in the features.

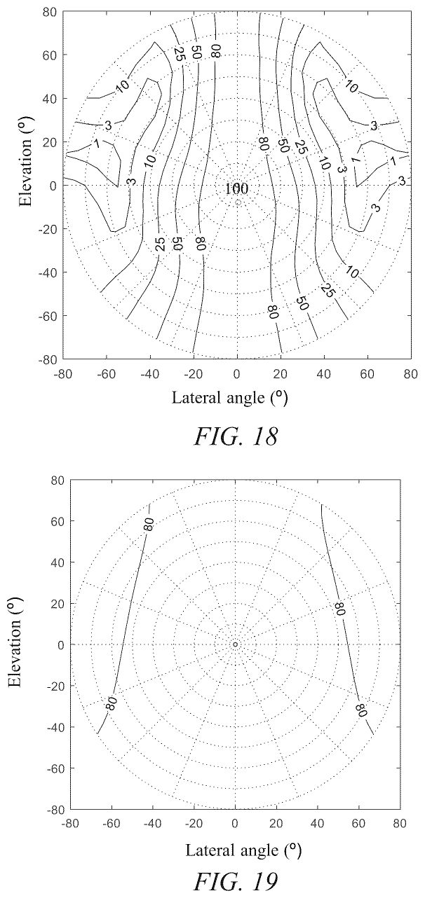

FIGS. 18-19 are schematic graphs illustrating the variation of output transmission with polar direction for transmitted light rays in FIG. 17 in a wide-angle and privacy mode of operation respectively, and provided by the arrangement of TABLE 9. Features of the embodiments of FIGS. 18-19 not discussed in further detail may be assumed to correspond to the features with equivalent reference numerals as discussed above, including any potential variations in the features.

TABLE 9

| | | Passive compensation retarder(s) | | Active LC retarder | | | | |
|---|---|---|---|---|---|---|---|---|
| | | | Δn.d/ | Alignment | Pretilt/ | Δn.d/ | | Voltage/ |
| FIG. | Mode | Type | nm | layers | deg | nm | Δε | V |
| 20 | Wide | Negative C | −1100 | Homogeneous | 2 | 1300 | +4.3 | 15.0 |
| 19 | Privacy | | | Homeotropic | 88 | | | 2.8 |
| Not shown | Wide | Crossed A | +1100 @ 45° | Homeotropic | 2 | 1300 | +4.3 | 15.0 |
| Not shown | Privacy | | +1100@ 135° | Homogeneous | 88 | | | 2.8 |

The hybrid aligned switchable guest-host liquid crystal retarder 301 has variable tilt such that for a given material and cell thickness choice, reduced effective birefringence is provided. Thus the retarder design must be adjusted to compensate in comparison to the arrangements wherein the alignment layers are the same. The switchable liquid crystal retarder 330 comprises a first surface alignment layer 417A disposed on a first side of the layer of liquid crystal material 423, and a second surface alignment layer 417B disposed on a second side of the layer of liquid crystal material 423 opposite the first side. The first surface alignment layer 417A is a homeotropic alignment layer arranged to provide homeotropic alignment in the adjacent liquid crystal material 423 and the second surface alignment layer 417B is a homogeneous alignment layer arranged to provide homogeneous alignment in the adjacent liquid crystal material 423.

Further, the optimum designs of retarders are related to the relative location of the passive compensation retarder 330 with respect to the homeotropic and homogeneous alignment layers.

When the surface alignment layer 417B arranged to provide homogeneous alignment is between the layer of liquid crystal material 423 and the compensation retarder 330, the layer of liquid crystal material 423 has a retardance for light of a wavelength of 550 nm in a range from 500 nm to 1800 nm, preferably in a range from 700 nm to 1500 nm and most preferably in a range from 900 nm to 1500 nm. When the surface alignment layer 417B arranged to provide homogeneous alignment is between the layer of liquid crystal material 423 and the compensation retarder 330, the passive compensation retarder may comprise a retarder 330 having its optical axis perpendicular to the plane of the retarder as shown in FIG. 17, the passive retarder 330 having a retardance for light of a wavelength of 550 nm in a range from −300 nm to −1600 nm, preferably in a range from −500 nm to −1300 nm and most preferably in a range from −700 nm to −1150 nm; or alternatively the passive compensation retarder may comprise a pair of retarders (not shown) which have optical axes in the plane of the retarders that are crossed, each retarder of the pair of retarders having a retardance for light of a wavelength of 550 nm in a range from 400 nm to 1600 nm, preferably in a range from 600 nm to 1400 nm and most preferably in a range from 800 nm to 1300 nm.

When the surface alignment layer 417A arranged to provide homeotropic alignment is between the layer of liquid crystal material 423 and the compensation retarder 330, the layer of liquid crystal material 423 has a retardance for light of a wavelength of 550 nm in a range from 700 nm to 2000 nm, preferably in a range from 1000 nm to 1700 nm and most preferably in a range from 1200 nm to 1500 nm. When the surface alignment layer 417A arranged to provide homeotropic alignment is between the layer of liquid crystal material 423 and the compensation retarder 330, the passive compensation retarder may comprise a retarder 330 having its optical axis perpendicular to the plane of the retarder as shown in FIG. 17, the passive retarder having a retardance for light of a wavelength of 550 nm in a range from −400 nm to −1800 nm, preferably in a range from −700 nm to −1500 nm and most preferably in a range from −900 nm to −1300 nm; or alternatively the passive compensation retarder may comprise a pair of retarders (not shown) which have optical axes in the plane of the retarders that are crossed, each retarder of the pair of retarders having a retardance for light of a wavelength of 550 nm in a range from 400 nm to 1800 nm, preferably in a range from 700 nm to 1500 nm and most preferably in a range from 900 nm to 1300 nm.

In comparison to the arrangement of FIG. 3A, the privacy mode of operation may advantageously achieve increased resilience to the appearance of material flow when the liquid crystal retarder is pressed.

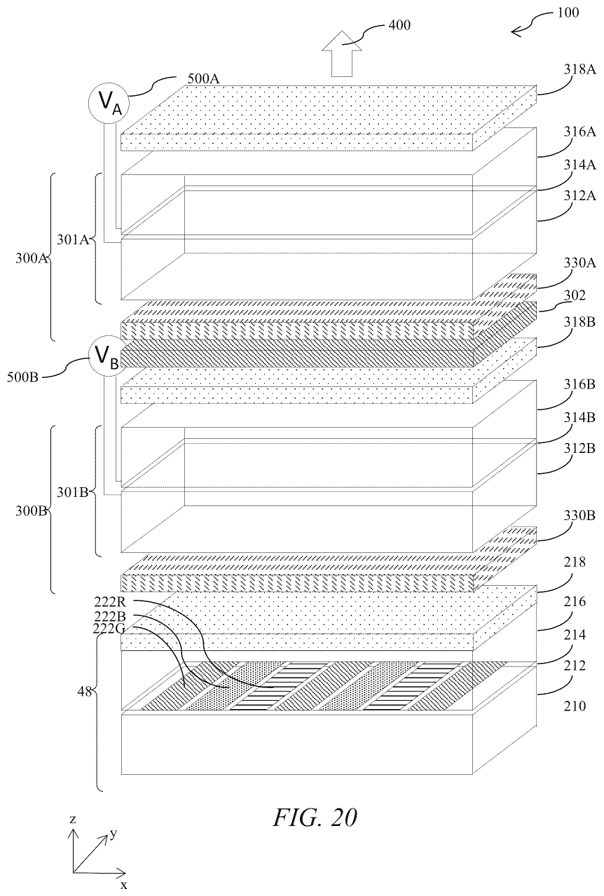

FIG. 20 is a schematic diagram illustrating in side perspective view an optical stack of a display device 100 comprising an emissive spatial light modulator 48 and a switchable guest-host liquid crystal retarder 301A and an additional switchable guest-host liquid crystal retarder 301B arranged on the output side of the emissive spatial light modulator 48. Features of the embodiment of FIG. 20 not discussed in further detail may be assumed to correspond to the features with equivalent reference numerals as discussed above, including any potential variations in the features.

By way of comparison with the embodiment of FIG. 1C, the alternative embodiment of FIG. 20 illustrates display device 100 comprising display polariser 218 that outputs light to a further polar control retarder 300B comprising further passive compensation retarder 330B, transparent substrates 312B, 316B and further switchable guest-host liquid crystal retarder 301B that is arranged to operate in a similar manner to the polar control retarder 300A. Optional further additional polariser 318B is provided to receive light from the further polar control retarder 300B and input light into the reflective polariser 302.

FIG. 20 may provide further reduction of off-axis luminance in privacy mode of operation. Advantageously the size of polar region for desirable security factor, S may be increased.

As may be used herein, the terms “substantially” and “approximately” provide an industry-accepted tolerance for its corresponding term and/or relativity between items. Such an industry-accepted tolerance ranges from zero percent to ten percent and corresponds to, but is not limited to, component values, angles, et cetera. Such relativity between items ranges between approximately zero percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. A display device comprising:
a spatial light modulator comprising a layer of addressable pixels;
a display polariser arranged on an output side of the spatial light modulator, the display polariser being a linear polariser;
a reflective polariser arranged on an output side of the display polariser, the reflective polariser being a linear polariser, wherein the reflective polariser and the display polariser have electric vector transmission directions that are parallel;
an additional polariser arranged on the output side of the reflective polariser, the additional polariser being a linear polariser;
and
a guest-host liquid crystal retarder arranged between the additional polariser and the reflective polariser, the guest-host liquid crystal retarder comprising a liquid crystal layer comprising a guest material and a host material, wherein the guest material is an anisotropic material and the host material is a liquid crystal material, the guest-host liquid crystal retarder being arranged on the same side of the spatial light modulator as the display polariser with the display polariser arranged between the guest-host liquid crystal retarder and the spatial light modulator,
wherein the optical axis of the guest-host liquid crystal retarder has an alignment component perpendicular to the plane of the guest-host liquid crystal retarder in at least a state of the host material.

2. A display device according to claim 1, wherein the anisotropic material is an anisotropic optical absorber.

3. A display device according to claim 2, wherein the anisotropic material is a dichroic dye or a pleochroic dye.

4. A display device according to claim 1, wherein the guest-host liquid crystal retarder is a switchable liquid crystal retarder further comprising transparent electrodes arranged to apply a voltage capable of switching the host material between different states.

5. A display device according to claim 4, further comprising a control system arranged to control the voltage applied across the electrodes of the at least one switchable liquid crystal retarder.

6. A display device according to claim 4, wherein, in each direction inclined to a normal to the display device, the difference between the maximum reflectance of the display device and the minimum reflectance of the display device across all switchable states of the host material is at most 15%.

7. A display device according to claim 4, wherein, in each switchable state of the host material, considering a combination of: the additional polariser; the guest-host liquid crystal retarder and any other retarder arranged between the additional polariser and the reflective polariser; and the reflective polariser, the contribution to the reflectance of the display device provided by that combination and excluding any surface reflections besides reflection from the reflective polariser is at most 15% in all directions inclined to a normal to the display device.

8. A display device according to claim 4, wherein, in at least one switchable state of the host material, the optical axis of the guest-host liquid crystal retarder has an alignment component perpendicular to the plane of the guest-host liquid crystal retarder.

9. A display device according to claim 1, wherein the guest material has a transmission in the visible spectrum that varies with wavelength.

10. A display device according to claim 9, wherein
the additional polariser has a transmission in the visible spectrum that monotonically increases with increasing wavelengths up to 475 nm and that is greater at all visible wavelengths above 475 nm than at a wavelength of 475 nm, and
the transmission in the visible spectrum of the guest material has a maximum value at a wavelength of at least 475 nm, preferably at least 500 nm.

11. A display device according to claim 9, wherein
the additional polariser has a transmission in the visible spectrum that is greater at all wavelengths below 475 nm than at 475 nm, and
the transmission in the visible spectrum of the guest material is greater at all wavelengths below 500 nm than at any wavelength in the range from 500 nm to 550 nm.

12. A display device according to claim 1, wherein the anisotropic material comprises an anisotropic metallic nanomaterial.

13. A display device according to claim 12, wherein the anisotropic metallic nanomaterial has a transparent electrically insulating surface layer.

14. A display device according to claim 1, wherein the volume of the guest material is less than 3%, preferably less than 2% and most preferably less than 1% of the volume of the host material.

15. A display device according to claim 1, wherein the weight of the guest material is less than 3%, preferably less than 2% and most preferably less than 1% of the weight of the host material.

16. A display device according to claim 1, wherein the guest material comprises a positive dichroic material or a positive pleochroic material and in at least one of the states, the optical axis of the guest-host liquid crystal retarder has an alignment component in the plane of the guest-host liquid crystal retarder that is orthogonal to the electric vector transmission direction of the display polariser.

17. A display device according to claim 1, wherein the on-axis extinction coefficient of the guest-host liquid crystal retarder in at least one mode of operation is at least 60%, preferably at least 80% and most preferably at least 90%.

18. A display device according to claim 1, further comprising at least one passive retarder arranged between the additional polariser and the reflective polariser.

19. A display device according to claim 1, wherein the display polariser, the reflective polariser and the additional polariser, have electric vector transmission directions that are parallel.

20. A display device according to claim 1, further comprising a backlight arranged to output light, wherein the spatial light modulator is a transmissive spatial light modulator arranged to receive output light from the backlight.

21. A display device according to claim 1, wherein the spatial light modulator comprises an emissive spatial light modulator arranged to output light and the display polariser is an output display polariser arranged on the output side of the emissive spatial light modulator.
